(19) United States
(12) Patent Application Publication
(10) Pub. No.: US 2021/0135803 A1
(43) Pub. Date: May 6, 2021

(54) RADIO (NR) UNLICENSED PHYSICAL UPLINK CONTROL CHANNEL WITH INTERLACED STRUCTURE

(71) Applicant: INTEL IP CORPORATION, Santa Clara, CA (US)

(72) Inventors: Wenting Chang, Beijing (CN); Salvatore Talarico, Sunnyvale, CA (US); Huaning Niu, San Jose, CA (US); Gang Xiong, Portland, OR (US); Jeongho Jeon, San Jose, CA (US)

(21) Appl. No.: 16/640,045

(22) PCT Filed: Aug. 17, 2018
(86) PCT No.: PCT/US2018/046914

§ 371 Date: Feb. 18, 2020

Related U.S. Application Data
(60) Provisional application No. 62/547,689, filed on Aug. 18, 2017.
(60) Provisional application No. 62/546,833, filed on Aug. 17, 2017.

(30) Foreign Application Priority Data
Aug. 21, 2017 (CN) PCT/CN2017/098302

(51) Int. Cl. H04L 5/00; H04W 74/08

(52) U.S. Cl. CPC H04L 5/005; H04W 74/0808; H04L 5/0064

(57) ABSTRACT

Technology for a next generation node B (gNB), operable for new radio (NR) unlicensed communication. The gNB can encode a discovery reference signal (DRS) in a single subframe. The DRS comprising a first synchronization signal (SS) block comprising a plurality of contiguous orthogonal frequency division multiplexed (OFDM) symbols in the single subframe. The DRS comprising a second SS block comprising a plurality of contiguous OFDM symbols in the single subframe. The DRS comprising a plurality of additional OFDM symbols for an SS block in the single subframe. The gNB can send the DRS in the single subframe to a user equipment (UE). The gNB can have a memory interface configured to send to a memory the DRS.

### BACKGROUND

Wireless systems typically include multiple User Equipment (UE) devices communicatively coupled to one or more Base Stations (BS). The one or more BSs may be Long Term Evolved (LTE) evolved NodeBs (eNB) or New Radio (NR) next generation NodeBs (gNB) that can be communicatively coupled to one or more UEs by a Third-Generation Partnership Project (3GPP) network.

Next generation wireless communication systems are expected to be a unified network/system that is targeted to meet vastly different and sometimes conflicting performance dimensions and services. New Radio Access Technology (RAT) is expected to support a broad range of use cases including Enhanced Mobile Broadband (eMBB), Massive Machine Type Communication (mMTC), Mission Critical Machine Type Communication (uMTC), and similar service types operating in frequency ranges up to 100 GHz.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 illustrates an example of illustrates a block diagram of an orthogonal frequency division multiple access (OFDMA) frame structure, in accordance with an example;

FIG. 2 illustrates an example of an example of a synchronization signal (SS) block transmission, in accordance with an example;

FIG. 3 illustrates an example of a contiguous SS transmission, in accordance with an example;

FIG. 4 illustrates another example of a contiguous SS transmission, in accordance with an example;

FIG. 5 illustrates another example of a contiguous SS transmission, in accordance with an example;

FIG. 6 illustrates an example of a discovery reference signal spanning in the frequency domain, in accordance with an example;

FIG. 7 illustrates an example of a flexible transmission duration, in accordance with an example;

FIG. 8 illustrates an example of a physical uplink shared channel (PUSCH) scheduling, in accordance with an example;

FIG. 9(a) illustrates an example of a floating PUSCH transmission, in accordance with an example;

FIG. 9(b) illustrates another example of a floating PUSCH transmission, in accordance with an example;

FIG. 10(a) illustrates an example of a PUSCH transmission within the configured orthogonal frequency demodulation (OFDM) symbol/slots, in accordance with an example;

FIG. 10(b) illustrates an example of a PUSCH transmission within the configured orthogonal frequency demodulation (OFDM) symbol/slots, in accordance with an example;

FIG. 10(c) illustrates an example of a PUSCH transmission within the configured orthogonal frequency demodulation (OFDM) symbol/slots, in accordance with an example;

FIG. 11 illustrates an example of a short physical uplink control channel (PUCCH) and long PUCCH, in accordance with an example;

FIG. 12 illustrates an example of a short PUCCH structure, in accordance with an example;

FIG. 13 illustrates an example of a long PUCCH structure, in accordance with an example;

FIG. 14 illustrates an example of an interlaced PUSCH for a Discrete Fourier Transformation-Spread-Orthogonal Frequency Division Multiplexing (DFT-s-OFDM) waveform, in accordance with an example;

FIG. 15 illustrates an example of an interlaced based short PUCCH, in accordance with an example;

FIG. 16 depicts functionality of a next generation node B (gNB), operable for new radio (NR) unlicensed communication, in accordance with an example;

FIG. 17 depicts functionality of a user equipment (UE), configured for floating physical uplink shared channel (PUSCH) transmission, in accordance with an example;

FIG. 18 depicts functionality of a user equipment (UE) configured to send uplink control information (UCI) in a new radio (NR) unlicensed physical uplink control channel (PUCCH), in accordance with an example;

FIG. 19 illustrates an architecture of a network in accordance with an example;

FIG. 20 illustrates a diagram of a wireless device (e.g., UE) and a base station (e.g., eNodeB) in accordance with an example;

FIG. 21 illustrates example interfaces of baseband circuitry in accordance with an example;

FIG. 22 illustrates a diagram of a wireless device (e.g., UE) in accordance with an example.

Reference will now be made to the exemplary embodiments illustrated, and specific language will be used herein to describe the same. It will nevertheless be understood that no limitation of the scope of the technology is thereby intended.

### DETAILED DESCRIPTION

Before the present technology is disclosed and described, it is to be understood that this technology is not limited to the particular structures, process actions, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating actions and operations and do not necessarily indicate a particular order or sequence.

### Example Embodiments

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

Mobile communication has evolved significantly from early voice systems to today's highly sophisticated integrated communication platform. Mechanisms are disclosed for configuration of downlink (DL) control channel monitoring occasions. Additionally, different options for defining UE behavior and handling of multiple DL control channel monitoring configurations from a single UE perspective are disclosed. The next generation wireless communication system, 5G, or new radio (NR) will provide access to information and sharing of data anywhere, at any time by various users and applications. NR is expected to be a unified network/system that is targeted to meet vastly different and sometime conflicting performance dimensions and services.

Such diverse multi-dimensional designs are driven by different services and applications. In general, NR will evolve based on 3GPP LTE-Advanced with additional potential new Radio Access Technologies (RATs) to enrich people lives with better, simple and seamless wireless connectivity solutions. NR will enable everything to be connected by wireless and deliver fast, rich contents and services.

In some embodiments, multiple work items can be performed to achieve a target in a licensed band. The scarcity and expensive cost of licensed spectrum can result in a deficit in the data rate boost. Thus, there can be emerging interests in the operation of a new radio system in an unlicensed spectrum.

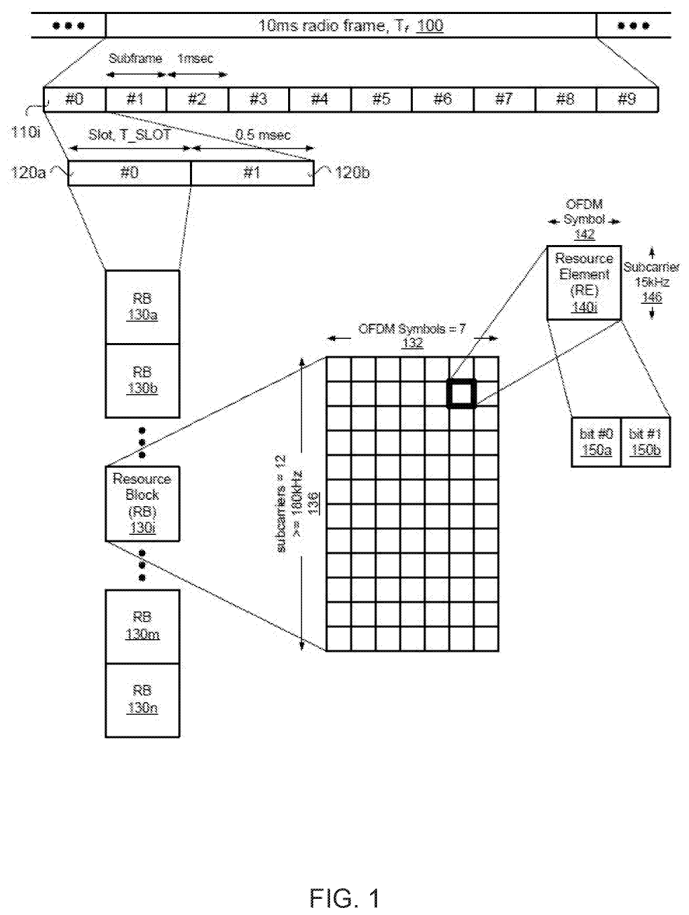

FIG. 1 provides an example of a 3GPP LTE Release 8 frame structure. In particular, FIG. 1 illustrates a downlink radio frame structure type 2. In the example, a radio frame 100 of a signal used to transmit the data can be configured to have a duration, T_{f}, of 10 milliseconds (ms). Each radio frame can be segmented or divided into ten subframes 110i that are each 1 ms long. Each subframe can be further subdivided into two slots 120a and 120b, each with a duration, Tₛₗₒₜ, of 0.5 ms. The first slot (#0) 120a can include a legacy physical downlink control channel (PDCCH) 160 and/or a physical downlink shared channel (PDSCH) 166, and the second slot (#1) 120b can include data transmitted using the PDSCH.

Each slot for a component carrier (CC) used by the node and the wireless device can include multiple resource blocks (RBs) 130a, 130b, 130i, 130m, and 130n based on the CC frequency bandwidth. The CC can have a carrier frequency having a bandwidth and center frequency. Each subframe of the CC can include downlink control information (DCI) found in the legacy PDCCH. The legacy PDCCH in the control region can include one to three columns of the first Orthogonal Frequency Division Multiplexing (OFDM) symbols in each subframe or RB, when a legacy PDCCH is used. The remaining 11 to 13 OFDM symbols (or 14 OFDM symbols, when legacy PDCCH is not used) in the subframe may be allocated to the PDSCH for data (for short or normal cyclic prefix).

Each RB (physical RB or PRB) 130i can include 12-15 kilohertz (kHz) subcarriers 136 (on the frequency axis) and 6 or 7 orthogonal frequency-division multiplexing (OFDM) symbols 132 (on the time axis) per slot. The RB can use seven OFDM symbols if a short or normal cyclic prefix is employed. The RB can use six OFDM symbols if an extended cyclic prefix is used. The resource block can be mapped to 84 resource elements (REs) 140i using short or normal cyclic prefixing, or the resource block can be mapped to 72 REs (not shown) using extended cyclic prefixing. The RE can be a unit of one OFDM symbol 142 by one subcarrier (i.e., 15 kHz) 146.

Each RE can transmit two bits 150a and 150b of information in the case of quadrature phase-shift keying (QPSK) modulation. Other types of modulation may be used, such as 16 quadrature amplitude modulation (QAM), 64 QAM or 256 QAM to transmit a greater number of bits in each RE, or bi-phase shift keying (BPSK) modulation to transmit a lesser number of bits (a single bit) in each RE. The RB can be configured for a downlink transmission from the eNodeB to the UE, or the RB can be configured for an uplink transmission from the UE to the eNodeB.

This example of the 3GPP LTE Release 8 frame structure provides examples of the way in which data is transmitted, or the transmission mode. The example is not intended to be limiting. Many of the Release 8 features will evolve and change in 5G frame structures included in 3GPP LTE Release 15, MulteFire Release 1.1, and beyond. In such a system, the design constraint can be on co-existence with multiple 5G numerologies in the same carrier due to the coexistence of different network services, such as eMBB (enhanced Mobile Broadband) 204, mMTC (massive Machine Type Communications or massive IoT) 202 and URLLC (Ultra Reliable Low Latency Communications or Critical Communications) 206. The carrier in a 5G system can be above or below 6 GHz. In one embodiment, each network service can have a different numerology.

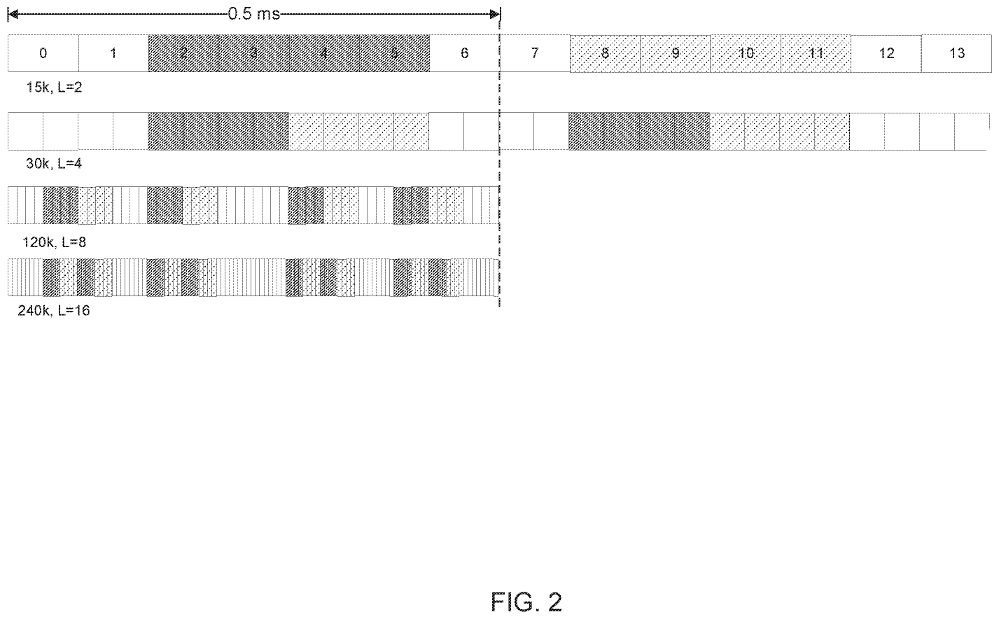

FIG. 2 illustrates an example of an example of a synchronization signal (SS) block transmission. In the initial access procedure, between adjacent synchronous signal blocks, there are some OFDM symbol gaps, which are reserved for guard period and uplink (UL) control, where L represents the number of SS blocks within a SS set. While in the unlicensed system, the channel is acquired by performing listen-before-talk (LBT), and LBT should be performed after each gap. In some embodiments, this will increase the system procedure, the channel may be snatched by other unlicensed system, and there can be an increase in channel delay as well. On the other hand, for an unlicensed system, the LBT period and the successful channel access probability is related to the channel occupancy time (COT) length, so it's preferred that the initial SS blocks don't span too many subframes. In some embodiments, in order to increase the high probability of successful channel acquisition, and a reliable discovery reference signal (DRS), including a primary synchronization signal (PSS)/secondary synchronization signal (SSS)/physical broadcast channel (PBCH) transmission, an innovative initial signal transmission can be utilized.

### Time Domain Enhancement

In one embodiment, the DRS subframes, including PSS/SSS/PBCH contain all downlink OFDM symbols.

### DRS One Subframe

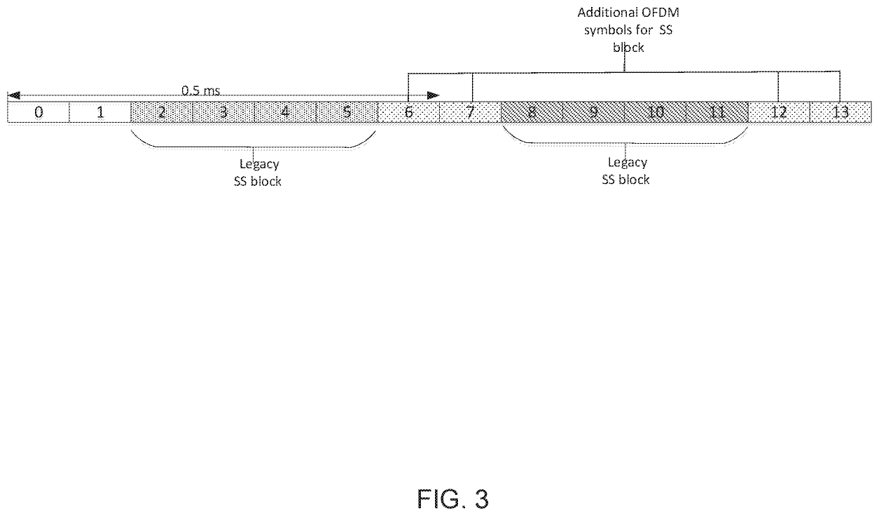

FIG. 3 illustrates an example of a contiguous synchronization signal (SS) transmission. In one embodiment, the OFDM symbols for an SS block of a licensed NR system are maintained for compatibility, while the N (e.g. 4), reserved contiguous/non-contiguous OFDM symbols are utilized for an additional SS block transmission. One example is illustrated in the FIG. 3, where the OFDM symbols 6/7/12/13 are reserved for an additional SS block transmission.

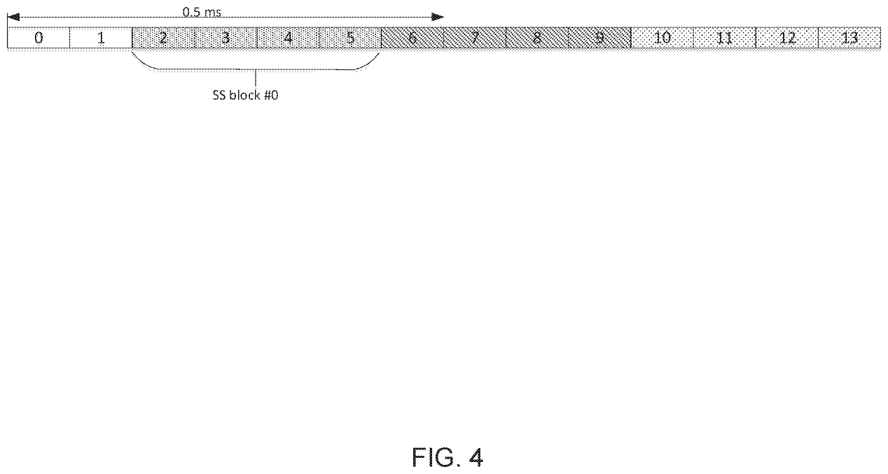

FIG. 4 illustrates another example of a contiguous SS transmission. In one embodiment, beside the starting one, two, or three OFDM symbols that may be reserved for PDCCH transmission, N (e.g. 4) contiguous OFDM symbols are grouped to transmit one SS block. One example is illustrated in the FIG. 4, OFDM symbols 2/3/4/5 are utilized for SS block #0 transmission, OFDM symbols 6/7/8/9 are utilized for SS block #1 transmission, and OFDM symbols 10/11/12/13 are utilized for an additional SS block.

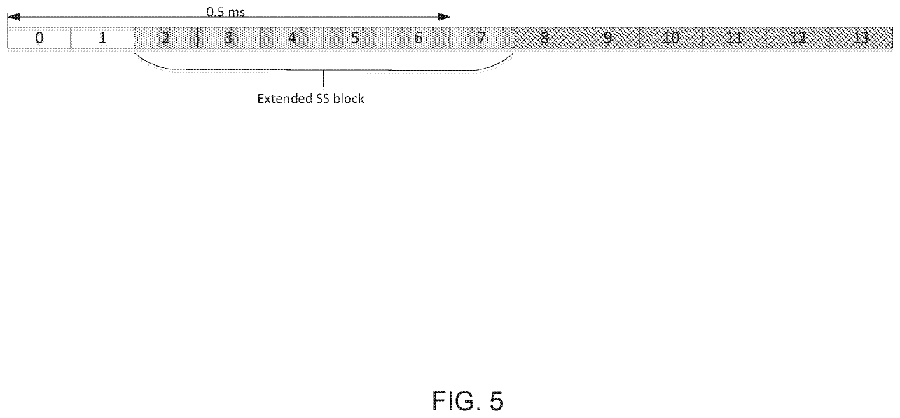

FIG. 5 illustrates another example of a contiguous SS transmission. In one embodiment, one SS block can be enhanced to more OFDM symbols, e.g. 5 or 6. Within the additional OFDM symbols, PSS and/or SSS and/or PBCH can be transmitted. If the additional symbol is utilized for PBCH, it can be realized by either rate matching to 3 OFDM symbols or repeating the second PBCH symbol, which can be utilized for another SS transmission.

In one example, the reserved OFDM symbols can be utilized for broadcasting downlink PDSCH transmission, e.g. system information block (SIB) and/or paging information. Alternatively, it can be utilized for unicast broadcasting downlink PDSCH transmission.

### DRS to Multiple Subframes

In one embodiment, the DRS may span to multiple reserved OFDM symbols. Besides the starting OFDM symbols, e.g. the first 1 or 2 symbols of the first subframe are typically reserved for PDCCH transmission. The starting OFDM symbols of the remaining subframes can be utilized for a SS block transmission, and/or a SIB, and or a paging transmission.

### Frequency Domain Enhancement

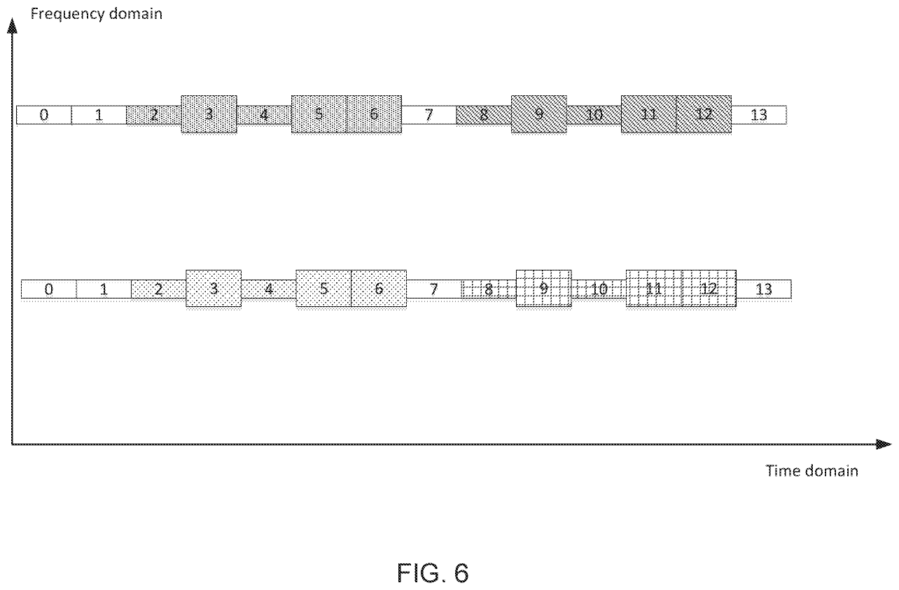

FIG. 6 illustrates an example of a discovery reference signal (DRS) spanning in the frequency domain. In one embodiment, multiple DRS, where each contains a PSS, SSS, and/or PBCH, can span to multiple resource blocks (RBs), so that the DRS can be transmitted within one subframe, or 12 OFDM symbols, which may only need a 25 us LBT, or a Cat.4 LBT with a priority class 1. The x-axis can represent the time domain, and the y-axis can represent the frequency domain. Additionally, each row represents an SS block, where in the example of FIG. 2, two rows represent two SS blocks being transmitted at the same time. In the frequency domain, different size means occupy different subcarriers, for example. PSS may occupy 72 subcarriers, while PBCH may occupy 144 subcarriers.

In one embodiment, the number of frequency resource sets for DRS transmission depends on the size L of SS blocks within an SS set, wherein L is the number of contiguous resource blocks in an SS set. Here, each frequency resource set contains at least 288 subcarriers. For instance, if L is 4, two frequency resources can be sufficient, where 4 SS resource blocks will be transmitted, as illustrated in FIG. 6. If two SS resource blocks are in the same time domain, then the two SS resource blocks in the frequency domain can be considered sufficient.

In another embodiment, the frequency offset between adjacent frequency resource sets can be pre-defined. Alternatively, the offset can be decided by the evolved Node B (eNB) itself, and the UE can be configured to perform a blind detection of the DRS based on a channel raster.

In one embodiment, the above embodiments can be together utilized as the enhancement proposed in the previous sections. This is further illustrated in FIG. 6, where 5 OFDM symbols are utilized for SS block transmission, and one additional OFDM is utilized for PBCH transmission.

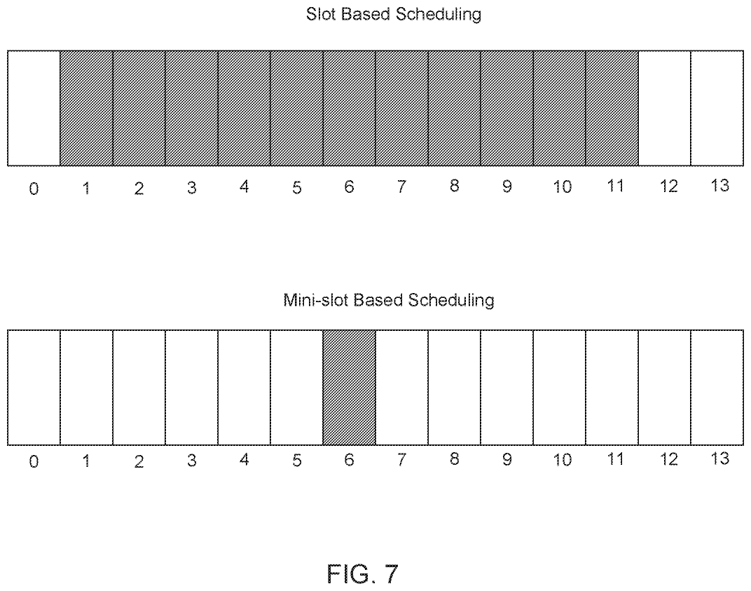

FIG. 7 illustrates an example of a flexible transmission duration. In the NR system, the PUSCH can have as short as 1 symbol duration and can start at any symbol in a slot. The resource allocation can be very flexible due to the dynamic TDD frame structure, dependent upon the DL/UL traffic demand. For instance, the gNB can schedule a mini-slot for a small packet as quickly as possible without waiting for the next slot boundary, while the gNB can also schedule multiple aggregated slots for large packets.

In the unlicensed system, an LBT is needed to be performed, e.g., by regulation and/or for coexistence with an incumbent system. Once the medium is detected idle, a transmission can be performed on the unlicensed spectrum. However, if the LBT fails, the whole slot resource will be dropped, which results in an inefficient resource utilization. In order to improve the resource utilization, a floating PUSCH transmission concept is proposed herein.

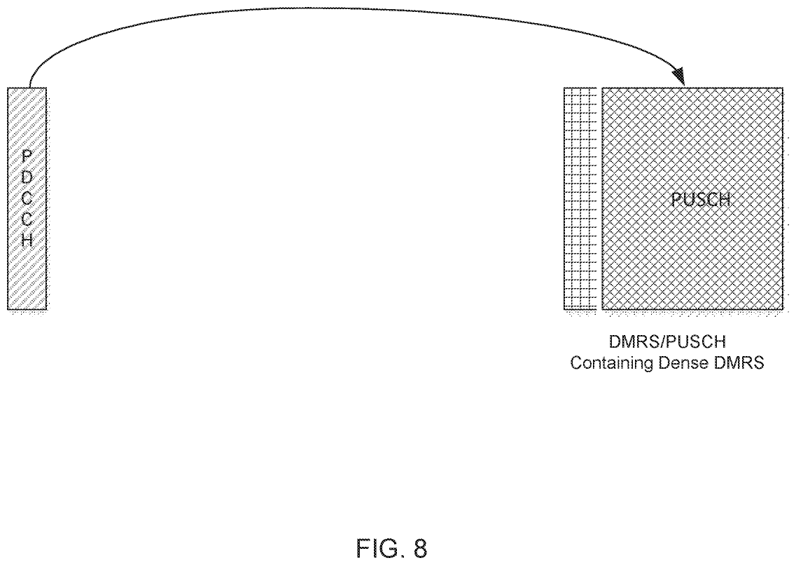

FIG. 8 illustrates an example of a physical uplink shared channel (PUSCH) scheduling. The FIG. 8 illustration further illustrates three different symbol regions, indicated by the different shaded areas. In one embodiment the DCI configures the PUSCH transmission related parameters, e.g. starting position, the number of OFDM symbols, and the frequency resource, modulation and coding scheme (MCS) and additional parameters.

### Floating PUSCH Transmission

In one embodiment, the PUSCH transmission in the configured time resource is floating. In one embodiment, the LBT before PUSCH transmission is configured by the eNB, where at least three LBT types can be configured. In the first type, there can be no LBT for the case when the PUSCH follows the preceding DL transmission in a sufficiently small gap described by regulation. In the second type, there can be a one shot LBT to support the PUSCH transmission within the eNB's acquired transmission opportunity. In the third type, there can be a Category 4 (Cat. 4) LBT, where the UE will acquire the channel occupancy by itself.

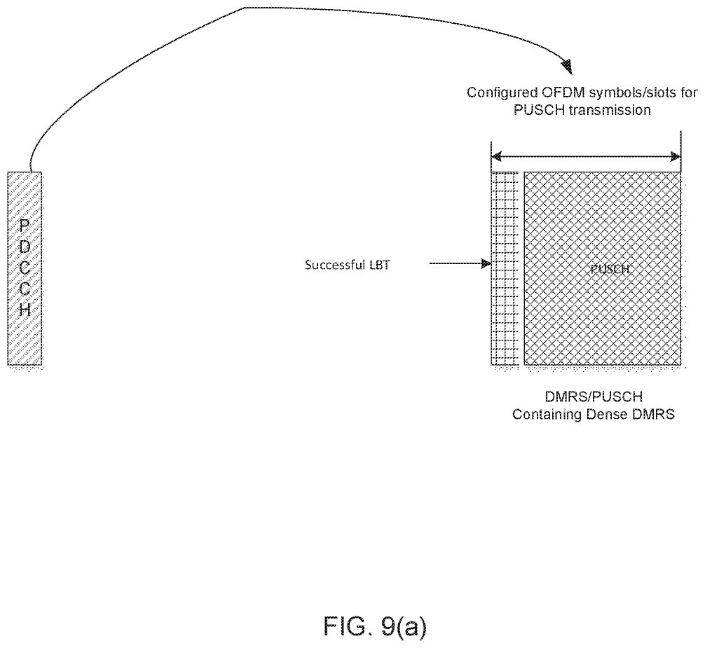

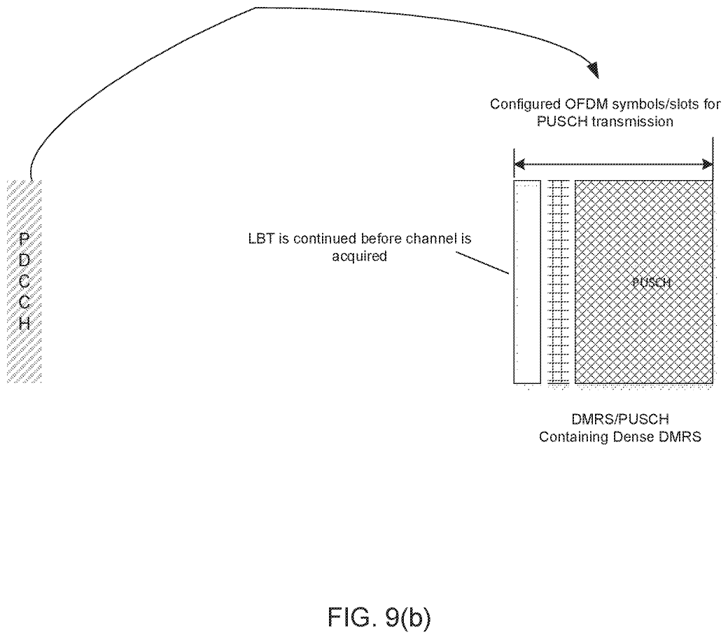

In one embodiment, the LBT may succeed in detecting an idle medium before the configured PUSCH starting position, and the PUSCH can be transmitted at the configured starting position. Additionally, the demodulation reference signal (DMRS) can be transmitted at least in the first PUSCH subframe, and it may or may not be transmitted in the remaining subframes, as illustrated in FIG. 9(a). The FIG. 9(a) illustration further illustrates three different symbol regions, indicated by the shaded areas.

In one embodiment, if the LBT does not detect an idle medium before the configured starting position of the PUSCH, the UE may continue to perform the LBT until it succeeds in detecting an idle medium by the configured ending position. One example is illustrated in FIG. 9(b), in which the UE acquires the channel at the first OFDM symbols in the slot. The UE can begin to transmit the PUSCH after it acquires the channel. The FIG. 9(b) illustration further illustrates four different symbol regions, indicated by the shaded areas.

### Timing Alignment Between the Configuration and Transmission

In one embodiment, when a UE acquires the channel occupancy in the middle of one of the OFDM symbols, the UE can self-defer to the boundary of the next OFDM symbol, or transmit the remaining partial symbol duration with the extension of the cyclic prefix of the next OFDM symbol.

In one embodiment, in the floating PUSCH transmission, the ending position of the PUSCH is confined within the configured OFDM symbols or slots.

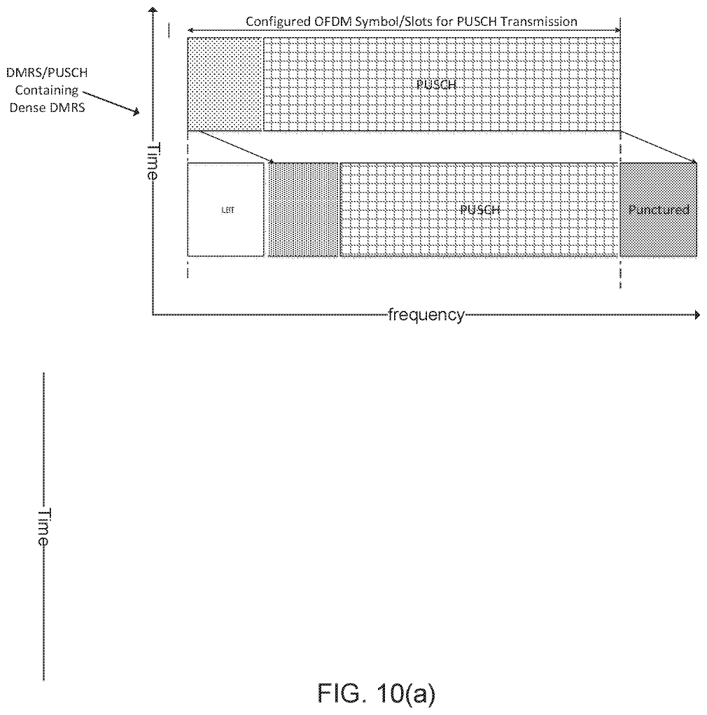

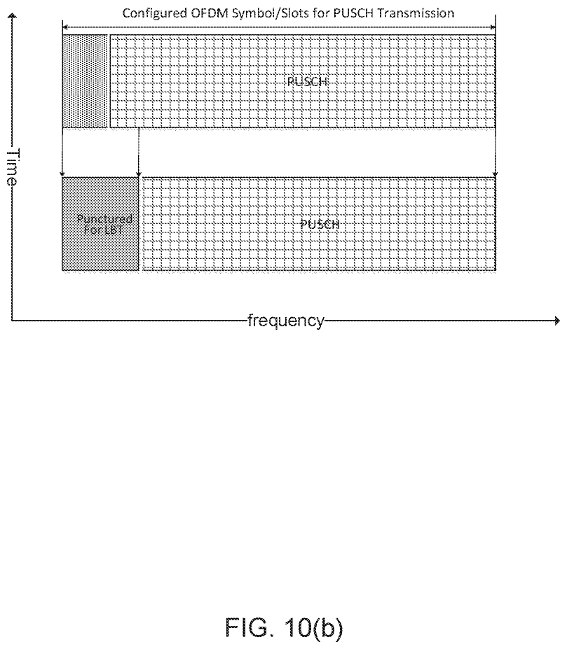

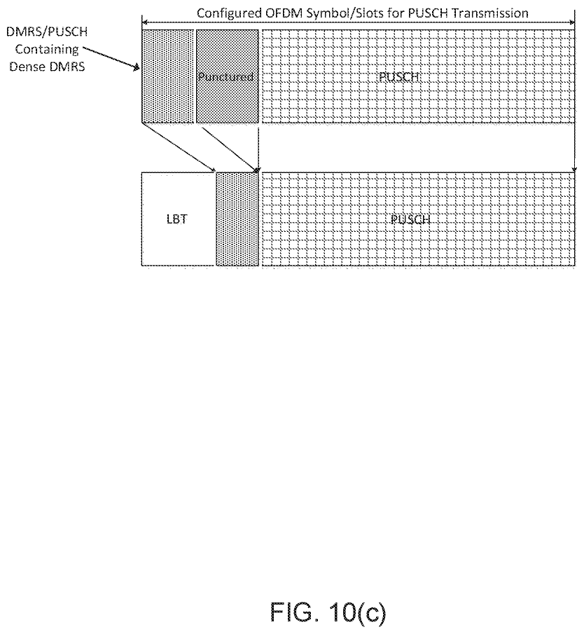

FIG. 10(a) illustrates an example of a PUSCH transmission within the configured orthogonal frequency demodulation (OFDM) symbol/slots. The prepared PUSCH symbols can be delayed correspondingly. For instance, if the LBT is successful in the first configured OFDM symbol, then the prepared first PUSCH symbol containing the DMRS can be transmitted at the second configured OFDM symbol, as illustrated in FIG. 10(a). The prepared PUSCH OFDM symbols are delayed accordingly, while the tail OFDM symbols are punctured. In one embodiment, the scrambling sequence can be generated based on the time information of the first configured OFDM symbol index. At the gNB side, the gNB can be configured to blindly detect the starting location of the PUSCH based on the DMRS.

FIG. 10(b) illustrates an example of a PUSCH transmission within the configured orthogonal frequency demodulation (OFDM) symbol/slots. The LBT can be configured to be successful in the middle of the configured time period. The prepared PUSCH symbols that are punctured, are those whose starting time is earlier in time than the instance of a successful LBT finish, while the remaining prepared PUSCH symbols are transmitted during the configured time after finishing LBT. As illustrated in the example FIG. 10(b), this can be applicable to the case where each OFDM symbol has an equal DMRS density as the first OFDM symbol, or has enough DMRS density, so that the gNB can perform the blind detection on each OFDM symbol.

FIG. 10(c) illustrates an example of a PUSCH transmission within the configured orthogonal frequency demodulation (OFDM) symbols or slots. To help the eNB in performing the blind detection, a special subframe can be utilized as the first OFDM symbol, which has sufficient DMRS density for the gNB to perform blind detection on each OFDM symbol. For instance, this special subframe can be a whole DMRS symbol, whose scrambling sequence is generated based on the first configured OFDM symbol or slot. Alternatively, it can be a data symbol with a higher DMRS density than other OFDM symbols.

In one embodiment, since code block-based acknowledgment (ACK)/non-acknowledgment (NACK) reporting and retransmission are supported in the NR system, the mapping can be a frequency mapping first, and then a time mapping. In this way, if the PUSCH containing the first code block (CB) cannot be transmitted due to a failed LBT, the PUSCH containing the second CB has the chance to be transmitted.

In one embodiment, x OFDM symbols can be encoded separately to reduce the loss of puncture, where x can be 1, 2, or a value configured by an eNB through downlink control information (DCI) or radio resource control (RRC) signaling.

Reduced Complexity for gNB's Blind Detection

In embodiments where the gNB needs to perform blind detection, it may increase the gNB's implementation complexity. To reduce the gNB's blind detection overhead, the floating window for LBT can be configured by the gNB.

In one embodiment, the starting consecutive x1 OFDM symbols/slots can be configured by gNB through a dynamic DCI or high layer signaling. The x1 can be equal to 0, representing that LBT can be performed earlier than the configured OFDM symbols/slots, which can be viewed as non-floating. The x1 can be larger than 0, representing that LBT can be performed even after passing the configured PUSCH starting position until the (x1)^{th} OFDM symbols/slots.

In one embodiment, multiple distributed LBT opportunities can be configured by gNB through dynamic DCI or higher layer signaling.

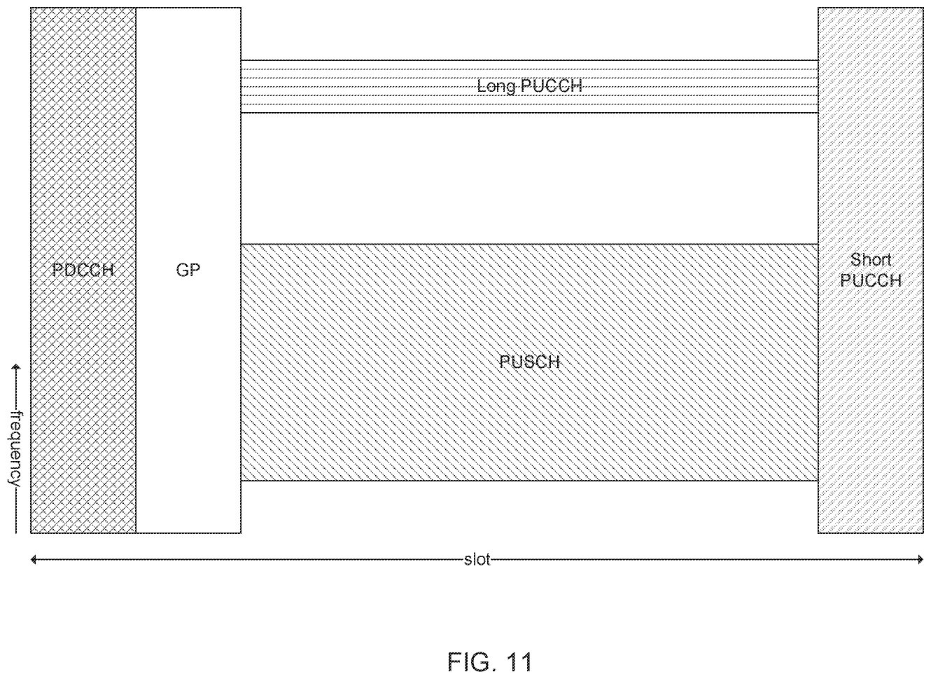

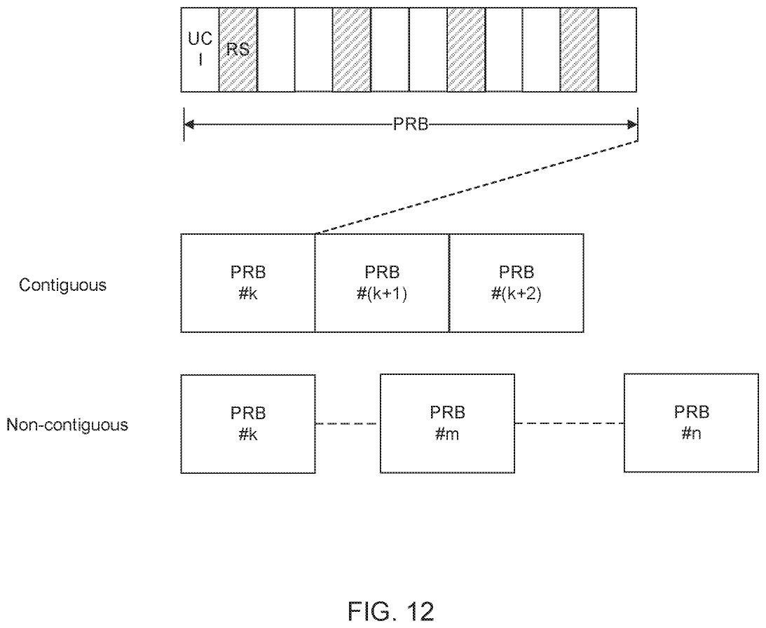

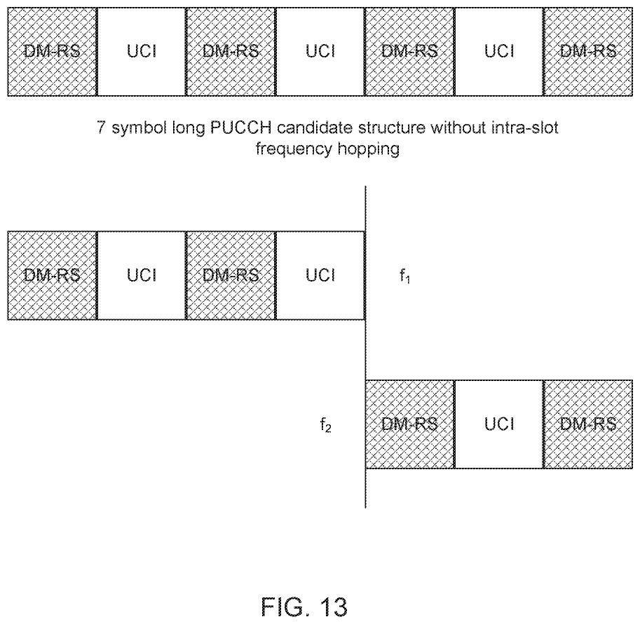

FIG. 11 illustrates an example of a short physical uplink control channel (PUCCH) and long PUCCH. In the NR system, there can be a configuration where two types of PUCCH are defined, as illustrated in FIG. 11. One configuration can be a short PUCCH based on cyclic prefix (CP)-OFDM, which occupies a maximum of 2 OFDM symbols within a slot. When utilizing a short PUCCH, as shown in FIG. 12, for 1-2 uplink control information (UCI) bits (HARQ with/without a scheduling request (SR)), the sequence selection with low Peak-to-Average Power Ratio (PAPR) is supported. When utilizing a short PUCCH for >2 bits in the UCI bits, the DMRS and UCI are frequency division multiplexed (FDMed) with Quadrature Phase Shift Keying (QPSK), and further configured with a ⅓ DMRS overhead. A long PUCCH, as shown in FIG. 13, can flexibly occupy 4˜ 14 OFDM symbols within a slot. Since the waveform of a long PUCCH is Discrete Fourier Transformation-Spread-Orthogonal Frequency Division Multiplexing (DFT-s-OFDM), the DMRS and UCI are TDMed. When utilizing a long PUCCH for 1-2 UCI bits, the DMRS occurs in every other symbols, and the UCI Binary Phase Shift Keying (BPSK)/QPSK symbol is multiplied with a sequence in the frequency domain, and the orthogonal cover code (OCC) is configured within the time domain. When utilizing a long PUCCH for >2 bits, UCI bits are encoded, scrambled, QPSK modulated, and DFT-pre-coded, similarly as a PUSCH.

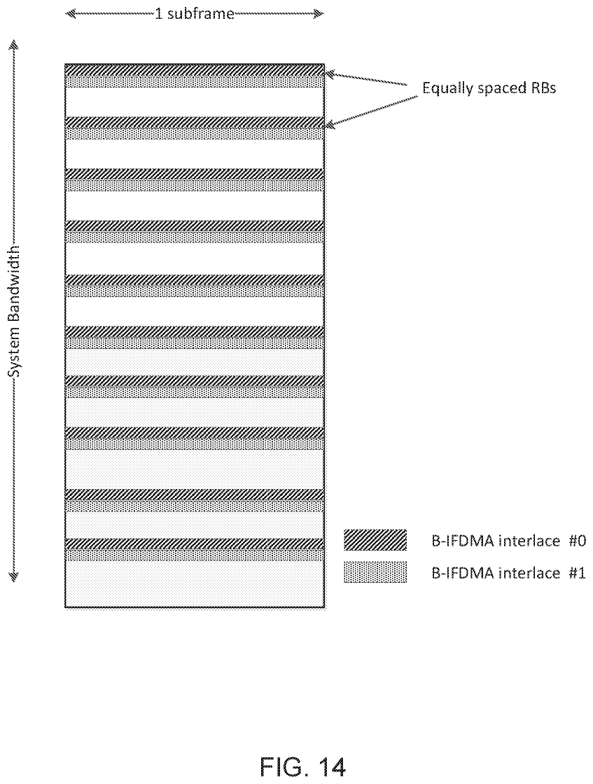

FIG. 14 illustrates an example of an interlaced PUSCH for a Discrete Fourier Transform-Spread-Orthogonal Frequency Division Multiplexing (DFT-s-OFDM) waveform. In order to satisfy the minimum occupied power unlicensed regulation, wherein a system is designed to occupy the 80% bandwidth, that is present in some regions, such as Europe, the Block-Interleaved Frequency Division Multiple Access (B-IFDMA) in the Discrete Fourier Transformation-Spread-Orthogonal Frequency Division Multiplexing (DFT-s-OFDM) waveform is proposed in eLAA for PUSCH transmission, as illustrated in the FIG. 14, where one interlace contains 10 equidistant RBs.

In one embodiment, there are two types of PUCCHs based on an interlace structure, where one is a short PUCCH design to support low UCI capacity having a high multiplexing capability; and the other is a long PUCCH design to support larger UCI capacity having a lesser multiplexing capability.

### Interlace Based Short PUCCH Design

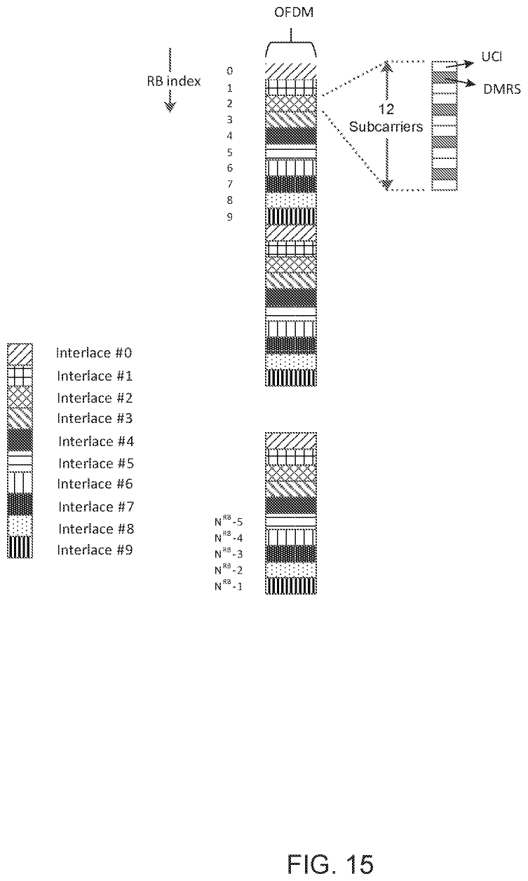

In one embodiment, the interlace based short PUCCH is proposed to satisfy the regulation of an occupied channel bandwidth. The occupied channel bandwidth can be 20M, wherein one transmission can occupy the 20*0.8M bandwidth. As illustrated in the FIG. 15, one or multiple contiguous, or non-contiguous interlaces can be configured for short PUCCH transmission.

In one embodiment, the UCI information bits are scrambled with a UE-specific scrambling sequence, i. e. \tilde{b}(0), . . . \tilde{b}(M_{bit}−1).

In one embodiment the block of scrambled bits \tilde{b}(0), . . . \tilde{b}(M_{bit}−1) is either BPSK or QPSK modulated, resulting in a block of modulation symbols d(0), . . . , d(M_{symb}−1), where M_{symb}=M_{bit}/2 for BPSK and QPSK, respectively.

In one embodiment, the modulation symbols d(0), . . . , d(M_{symb}−1) can be multiplexed with the orthogonal sequence of w_{oc,intra}^{(p̅),short-PUCCH} of length d_{oc,intra}^{(p̅),short-PUCCH}, e.g. 1/2/4/6/8/10 within one cyclic prefix-based OFDM (CP-OFDM) symbol for each of the antenna ports used for short PUCCH transmission according to

y(nN_{oc,intra}^{(p̅),short-PUCCH}+i)=d(n)w_{oc,intra}^{(p̅),short-PUCCH}

where
i=0, 1 . . . . N_{oc,intra}^{(p̅),short-PUCCH}−1
n=0, 1 . . . M_{symb}−1

In one embodiment, the RB number can be denoted for the short PUCCH as M_{RB}^{short-PUCCH}, it's the integer times the RB number of one interlace. The intra-symbol spread modulation symbols y^{(p̅)} are divided into M_{RB}^{short-PUCCH} sets, where each set contains eight BPSK/QPSK symbols. Each set can be associated with one RB within one or multiple interlaces in the increasing/decreasing order, and the eight BPSK/QPSK symbols can be mapped to eight subcarriers in the increasing/decreasing order.

In one embodiment, if more than one OFDM symbol is assigned, the OCC or repetition can be applied to span to multiple OFDM symbols. Alternatively, the channel coding can be performed through multiple OFDM symbols. In the alternative, the CP-OFDM symbol can also be generated.

In one embodiment, in the case where the short PUCCH has a different numerology as the remaining interlaces, one or multiple subcarriers at upper/down sides can be left as vacant.

In one embodiment, the LBT type can be indicated by the eNB, or pre-defined. For example, the LBT type can be configured by the eNB through higher layer signaling, or by using downlink control information (DCI). For example, for a 1 bit indicator, there can be a “0” for no LBT, and a “1” for a one shot LBT. For example, for a 2 bit indicator, there can be a “00” for no LBT, a “01” for a one shot LBT, a “10” for a Category 4 LBT where the priority class can be pre-defined or configured by the gNB, and “11” can be reserved. This can enable the eNB to perform flexible scheduling. For instance, the eNB can configure the PDCCH/PDSCH/PUCCH/PUSCH before the short PUCCH starting without the gap, or a gap smaller than 16 us. In this case the short PUCCH can be transmitted without the LBT. Alternatively, a blank OFDM symbol may exist before the short PUCCH transmission, where the one shot LBT is then performed. These examples are not intended to be limiting. The 1 bit or 2 bit indicator can also be used to differently distinguish the different types of LBT, as can be appreciated.

### Interlace Based Lone PUCCH Design

In one embodiment, the interlace based long PUCCH is proposed to satisfy the regulation of an occupied channel bandwidth. As illustrated in the previously described FIG. 14, one or multiple contiguous or non-contiguous interlaces can be configured for short PUCCH transmission.

In one embodiment, the UCI information bits are scrambled with a UE-specific scrambling sequence, i. e. \tilde{b}(0), . . . \tilde{b}(M_{bit}−1).

In one embodiment, the block of scrambled bits \tilde{b}(0), . . . \tilde{b}(M_{bit}−1) is either BPSK or QPSK modulated, resulting in a block of modulation symbols d(0), . . . , d(M_{symb}−1), where M_{symb}=M_{bit}, M_{symb}=M_{bit}/2 for BPSK and QPSK, respectively.

In one embodiment, the modulation symbols d(0), . . . , d(M_{symb}−1) can be block-wise spread with the orthogonal sequences. In the first option, d(0), . . . , d(M_{symb}−1) are divided into two groups. One is d (0), . . . , d(M_{symb}/2−1), which is spread with w_{oc,interSF,0}^{(p̅)}, and the other one is d(M_{symb}/2), . . . , d(M_{symb}−1), which is spread with w_{oc,interSF,1}^{(p̅)}. Here the length of w_{oc,interSF,0}^{(p̅)} and w_{oc,interSF,1}^{(p̅)} can be equal to the assigned OFDM symbols in the first half slot, and the assigned OFDM symbols in the second half slot, respectively. Alternatively, w_{oc,interSF,0}^{(p̅)}=w_{oc,interSF,1}^{(p̅)}=N_{OFDM}/2, where N_{OFDM} is the total assigned OFDM number for the long PUCCH transmission. In the second option, d(0), . . . , d(M_{symb}−1) is spread with w_{oc,interSF}^{(p̅)}, where the length of w_{oc,interSF,0}^{(p̅)} is equal to the assigned OFDM number for the long PUCCH transmission.

In one embodiment, during the block-wise, the cell specific shift can be multiplied

$${e}^{j π ⌊ {n}_{CS}^{cell} ( {n}_{s} , 1 ) / 64 ⌋ / 2}$$

on each symbol.

In one embodiment, before mapping to the physical resource, the BPSK/QPSK is cyclically shifted with offset n_{cs}^{cell}(nₛ,l). The CP-OFDM, can also be generated after the cyclic shift.

In one embodiment, one or multiple subcarriers at upper/down sides, can be left as vacant. This can occur, in the case where the long PUCCH has a different numerology as the remaining interlaces.

In one embodiment, the LBT type can be indicated by the eNB, or pre-defined. The LBT can be configured by the eNB through higher layer signaling, or the DCI. Taking the 1 bit indicator as an example, there can be a “0” for no LBT, and a “1” for one shot LBT. Taking the 2 bit indicator as an example, there can be a “00” for no LBT, a “01” for one shot LBT, a “10” for Cat.4 LBT where the priority class can be pre-defined or configured by eNB, and a “11” is reserved. This can enable the eNB to perform flexible scheduling. For instance, the eNB can configure the PDCCH before the long PUCCH starting without the gap, or a gap smaller than 16 us. Then, the long PUCCH can be transmitted without LBT. Alternatively, the long PUCCH starts at the first OFDM symbol, where the one shot LBT, or the Cat.4 LBT is performed. This embodiment can further be considered to be an interlaced based PUCCH. These examples are not intended to be limiting. The 1 bit or 2 bit indicator can also be used to differently distinguish the different types of LBT, as can be appreciated.

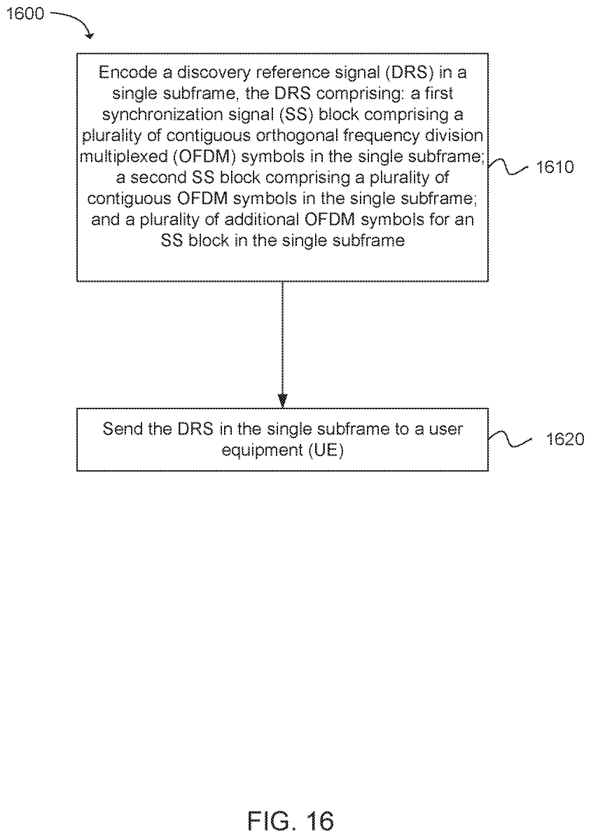

FIG. 16 depicts functionality 1600 of a next generation node B (gNB), operable for new radio (NR) unlicensed communication. The gNB can comprise one or more processors configured to encode a discovery reference signal (DRS) in a single subframe 1610. The DRS can comprise a first synchronization signal (SS) block comprising a plurality of contiguous orthogonal frequency division multiplexed (OFDM) symbols in the single subframe. The DRS can comprise a second SS block comprising a plurality of contiguous OFDM symbols in the single subframe. The DRS can comprise a plurality of additional OFDM symbols for an SS block in the single subframe. The one or more processors are further configured to send the DRS in the single subframe to a user equipment (UE) 1620.

In one embodiment, the one or more processors are further configured to select a first two symbols in the single subframe to be reserved for a physical downlink control channel (PDCCH).

In one embodiment, the one or more processors are further configured to encode the first SS block in four contiguous symbols located after OFDM symbols in the single subframe that are reserved for physical downlink control channel (PDCCH) transmission.

In one embodiment, the one or more processors are further configured to encode the second SS block in four contiguous symbols located adjacent to the first SS block.

In one embodiment, the one or more processors are further configured to encode the plurality of additional OFDM symbols in four adjacent symbols located adjacent to the second SS block.

In one embodiment, the one or more processors are further configured to encode the second SS block with in four adjacent symbols that are located after the first SS block, wherein the additional ODFM symbols are located prior to and after the second SS block in the single subframe.

In one embodiment, the one or more processors are further configured to encode an extended SS block in five or six contiguous symbols located after OFDM symbols in the single subframe that are reserved for physical downlink control channel (PDCCH) transmission; and encode the second SS block in five or six contiguous symbols located adjacent to the first SS block.

In one embodiment, the one or more processors are further configured to encode a primary synchronization signal (PSS), a secondary synchronization signal (SSS), or a physical broadcast channel (PBCH) in the extended SS block.

In one embodiment, the one or more processors are further configured to select one or more of the additional OFDM symbols for transmission of a physical broadcast channel (PBCH), wherein each of the additional OFDM symbols are rate matched to three OFDM symbols or repeated in a second transmission.

In one embodiment, the one or more processors are further configured to select one or more of the additional OFDM symbols for broadcasting a system information block (SIB) or a page in a physical downlink shared channel (PDSCH) transmission; or select the one or more additional OFDM symbols for unicast broadcasting in the PDSCH transmission.

In one embodiment, the one or more processors are further configured to encode multiple DRS within the single subframe using resource blocks (RBs) in the frequency domain.

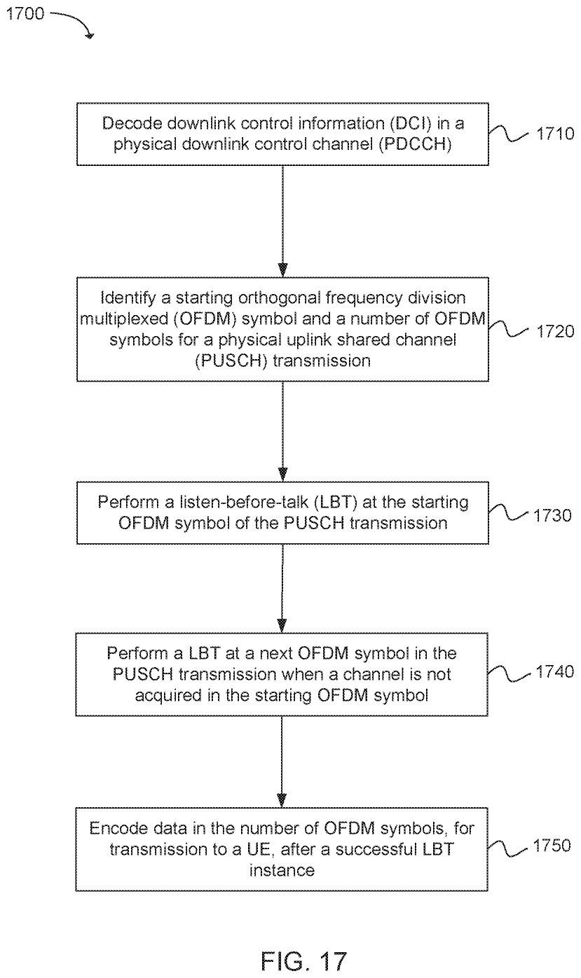

FIG. 17 depicts functionality 1700 of a user equipment (UE), configured for floating physical uplink shared channel (PUSCH) transmission. The UE can comprise one or more processors configured to decode downlink control information (DCI) in a physical downlink control channel (PDCCH) 1710. The UE can comprise one or more processors configured to identify a starting orthogonal frequency division multiplexed (OFDM) symbol and a number of OFDM symbols for a physical uplink shared channel (PUSCH) transmission 1720. The UE can comprise one or more processors configured to perform a listen-before-talk (LBT) at the starting OFDM symbol of the PUSCH transmission 1730. The UE can comprise one or more processors configured to perform a LBT at a next OFDM symbol in the PUSCH transmission when a channel is not acquired in the starting OFDM symbol 1740. The UE can comprise one or more processors configured to encode data in the number of OFDM symbols, for transmission to a UE, after a successful LBT instance 1750.

In one embodiment, the one or more processors are further configured to encode the data for transmission in the number of OFDM symbols after the LBT succeeds; delay the encoded data based on a number of OFDM symbols used for the LBT; puncture tail OFDM symbols of the delayed encoded data based on the number of OFDM symbols used for the LBT; and scramble the delayed encoded data in the number of OFDM symbols using a scrambling sequence that is generated based on time information of a first configured OFDM symbol index of the starting OFDM symbol.

In one embodiment, the one or more processors are further configured to encode the data for transmission in the number of OFDM symbols after the LBT succeeds; delay the encoded data based on a number of OFDM symbols used for the LBT; puncture starting OFDM symbols of the delayed encoded data that have a starting time that is earlier in time than a completion of the successful LBT instance; and send a remaining OFDM symbols of the number of OFDM symbols to the UE.

In one embodiment, the one or more processors are further configured to encode the data for transmission in the remaining OFDM symbols, where the data is encoded with sufficient density to enable a next generation node B to perform blind detection on each of the remaining OFDM symbols.

In one embodiment, the one or more processors are further configured to encode a first symbol of the remaining OFDM symbols with sufficient demodulation reference signal (DMRS) density, to enable a next generation Node B gNB to blindly detect a starting of the PUSCH transmission.

In one embodiment, the one or more processors are further configured to encode the first symbol of the remaining OFDM symbols with a full DMRS symbol having a scrambling sequence that is generated based on time information of a first configured OFDM symbol index of the starting OFDM symbol; or encode the first symbol of the remaining OFDM symbols with a higher DMRS density than a DMRS density of following symbols.

In one embodiment, the one or more processors are further configured to map the data in the number of OFDM symbols, wherein the mapping comprises frequency mapping first, and then time mapping.

In one embodiment, the one or more processors are further configured to encode one or more OFDM symbols in the number of OFDM symbols for transmission in a separate PUSCH transmission to reduce a loss of data due to puncturing.

In one embodiment, the one or more processors are further configured to decode a starting OFDM symbol for a PUSCH transmission, received from a next generation Node B (gNB) in downlink control information or radio resource control (RRC) signaling.

In one embodiment, the one or more processors are further configured to decode one or more LBTs received from a next generation node B.

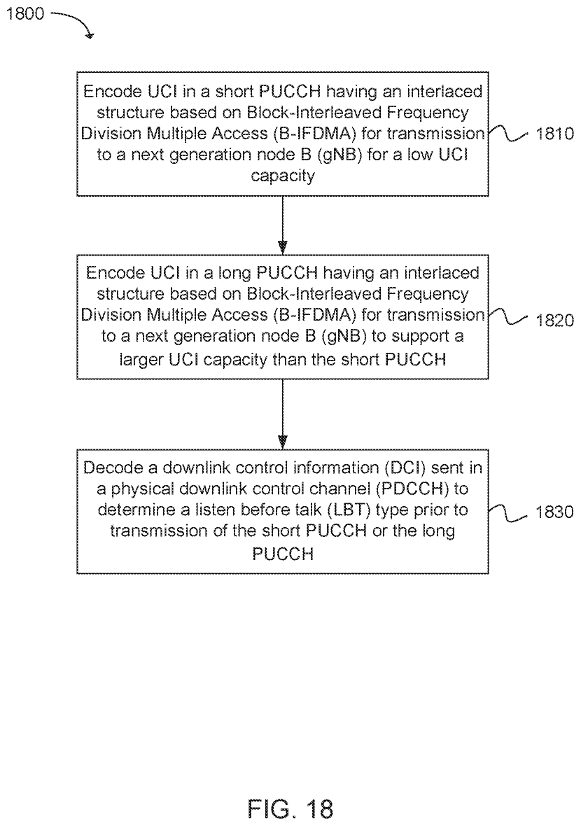

FIG. 18 depicts functionality 1800 of a user equipment (UE) configured to send uplink control information (UCI) in a new radio (NR) unlicensed physical uplink control channel (PUCCH). The UE can comprise one or more processors configured to encode UCI in a short PUCCH having an interlaced structure based on Block-Interleaved Frequency Division Multiple Access (B-IFDMA) for transmission to a next generation node B (gNB) for a low UCI capacity 1810. The UE can comprise one or more processors configured to encode UCI in a long PUCCH having an interlaced structure based on Block-Interleaved Frequency Division Multiple Access (B-IFDMA) for transmission to a next generation node B (gNB) to support a larger UCI capacity than the short PUCCH 1820. The UE can comprise one or more processors configured to decode a downlink control information (DCI) sent in a physical downlink control channel (PDCCH) to determine a listen before talk (LBT) type prior to transmission of the short PUCCH or the long PUCCH 1830.

In one embodiment, the one or more processors are further configured to decode the DCI sent in the PDCCH; and identify the LBT type, in a one-bit indicator in the DCI.

In one embodiment, the one or more processors are further configured to determine the LBT type from the one-bit indicator wherein a first bit type indicates no LBT and a second bit type indicates a one shot LBT.

In one embodiment, the one or more processors are further configured to decode the DCI sent in the PDCCH; and identify the LBT type, in a two-bit indicator in the DCI.

In one embodiment, the one or more processors are further configured to determine the LBT type from the two-bit indicator wherein: a first bit type indicates no LBT; a second bit type indicates a one shot LBT; and a third bit type indicates a category 4 (Cat. 4) LBT.

In one embodiment, the one or more processors are further configured to decode a priority class of the Cat. 4 LBT, wherein the priority class is received in a radio resource control (RRC) message from the gNB.

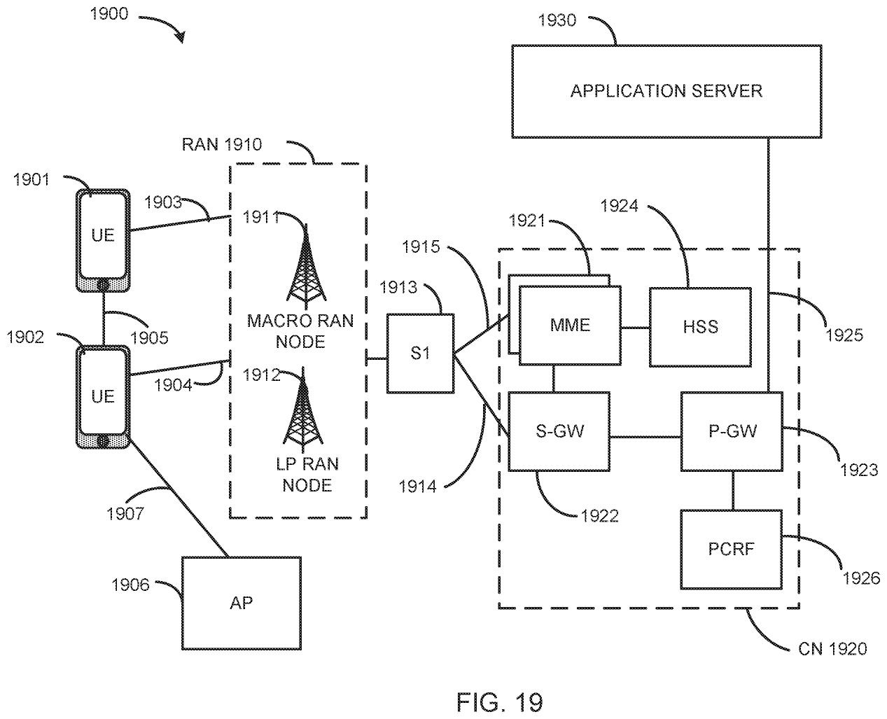

FIG. 19 illustrates architecture of a system 1900 of a network in accordance with some embodiments. The system 1900 is shown to include a user equipment (UE) 1901 and a UE 1902. The UEs 1901 and 1902 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UEs 1901 and 1902 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 1901 and 1902 may be configured to connect, e.g., communicatively couple, with a radio access network (RAN) 1910—the RAN 1910 may be, for example, an Evolved Universal Mobile Telecommunications System (UMTS) Terrestrial Radio Access Network (E-UTRAN), a Ne8Gen RAN (NG RAN), or some other type of RAN. The UEs 1901 and 1902 utilize connections 1903 and 1904, respectively, each of which comprises a physical communications interface or layer (discussed in further detail below); in this example, the connections 1903 and 1904 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 1901 and 1902 may further directly exchange communication data via a ProSe interface 1905. The ProSe interface 1905 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1902 is shown to be configured to access an access point (AP) 1906 via connection 1907. The connection 1907 can comprise a local wireless connection, such as a connection consistent with any IEEE 802.11 protocol, wherein the AP 1906 would comprise a wireless fidelity (WiFi®) router. In this example, the AP 1906 is shown to be connected to the Internet without connecting to the core network of the wireless system (described in further detail below).

The RAN 1910 can include one or more access nodes that enable the connections 1903 and 1904. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The RAN 1910 may include one or more RAN nodes for providing macrocells, e.g., macro RAN node 1911, and one or more RAN nodes for providing femtocells or picocells (e.g., cells having smaller coverage areas, smaller user capacity, or higher bandwidth compared to macrocells), e.g., low power (LP) RAN node 1912.

Any of the RAN nodes 1911 and 1912 can terminate the air interface protocol and can be the first point of contact for the UEs 1901 and 1902. In some embodiments, any of the RAN nodes 1911 and 1912 can fulfill various logical functions for the RAN 1910 including, but not limited to, radio network controller (RNC) functions such as radio bearer management, uplink and downlink dynamic radio resource management and data packet scheduling, and mobility management.

In accordance with some embodiments, the UEs 1901 and 1902 can be configured to communicate using Orthogonal Frequency-Division Multiplexing (OFDM) communication signals with each other or with any of the RAN nodes 1911 and 1912 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 1911 and 1912 to the UEs 1901 and 1902, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UEs 1901 and 1902. The physical downlink control channel (PDCCH) may carry information about the transport format and resource allocations related to the PDSCH channel, among other things. It may also inform the UEs 1901 and 1902 about the transport format, resource allocation, and H-ARQ (Hybrid Automatic Repeat Request) information related to the uplink shared channel. Typically, downlink scheduling (assigning control and shared channel resource blocks to the UE 102 within a cell) may be performed at any of the RAN nodes 1911 and 1912 based on channel quality information fed back from any of the UEs 1901 and 1902. The downlink resource assignment information may be sent on the PDCCH used for (e.g., assigned to) each of the UEs 1901 and 1902.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN 1910 is shown to be communicatively coupled to a core network (CN) 1920—via an S1 interface 1913. In embodiments, the CN 1920 may be an evolved packet core (EPC) network, a Next Gen Packet Core (NPC) network, or some other type of CN. In this embodiment the S1 interface 1913 is split into two parts: the S1-U interface 1914, which carries traffic data between the RAN nodes 1911 and 1912 and the serving gateway (S-GW) 1922, and the S1-mobility management entity (MME) interface 1915, which is a signaling interface between the RAN nodes 1911 and 1912 and MMEs 1921.

In this embodiment, the CN 1920 comprises the MMEs 1921, the S-GW 1922, the Packet Data Network (PDN) Gateway (P-GW) 1923, and a home subscriber server (HSS) 1924. The MMEs 1921 may be similar in function to the control plane of legacy Serving General Packet Radio Service (GPRS) Support Nodes (SGSN). The MMEs 1921 may manage mobility aspects in access such as gateway selection and tracking area list management. The HSS 1924 may comprise a database for network users, including subscription-related information to support the network entities' handling of communication sessions. The CN 1920 may comprise one or several HSSs 1924, depending on the number of mobile subscribers, on the capacity of the equipment, on the organization of the network, etc. For example, the HSS 1924 can provide support for routing/roaming, authentication, authorization, naming/addressing resolution, location dependencies, etc.

The S-GW 1922 may terminate the S1 interface 1913 towards the RAN 1910, and routes data packets between the RAN 1910 and the CN 1920. In addition, the S-GW 1922 may be a local mobility anchor point for inter-RAN node handovers and also may provide an anchor for inter-3GPP mobility. Other responsibilities may include lawful intercept, charging, and some policy enforcement.

The P-GW 1923 may terminate an SGi interface toward a PDN. The P-GW 1923 may route data packets between the EPC network 1923 and external networks such as a network including the application server 1930 (alternatively referred to as application function (AF)) via an Internet Protocol (IP) interface 1925. Generally, the application server 1930 may be an element offering applications that use IP bearer resources with the core network (e.g., UMTS Packet Services (PS) domain, LTE PS data services, etc.). In this embodiment, the P-GW 1923 is shown to be communicatively coupled to an application server 1930 via an IP communications interface 1925. The application server 1930 can also be configured to support one or more communication services (e.g., Voice-over-Internet Protocol (VoIP) sessions, PTT sessions, group communication sessions, social networking services, etc.) for the UEs 1901 and 1902 via the CN 1920.

The P-GW 1923 may further be a node for policy enforcement and charging data collection. Policy and Charging Enforcement Function (PCRF) 1926 is the policy and charging control element of the CN 1920. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 1926 may be communicatively coupled to the application server 1930 via the P-GW 1923. The application server 1930 may signal the PCRF 1926 to indicate a new service flow and select the appropriate Quality of Service (QoS) and charging parameters. The PCRF 1926 may provision this rule into a Policy and Charging Enforcement Function (PCEF) (not shown) with the appropriate traffic flow template (TFT) and QoS class of identifier (QCI), which commences the QoS and charging as specified by the application server 1930.

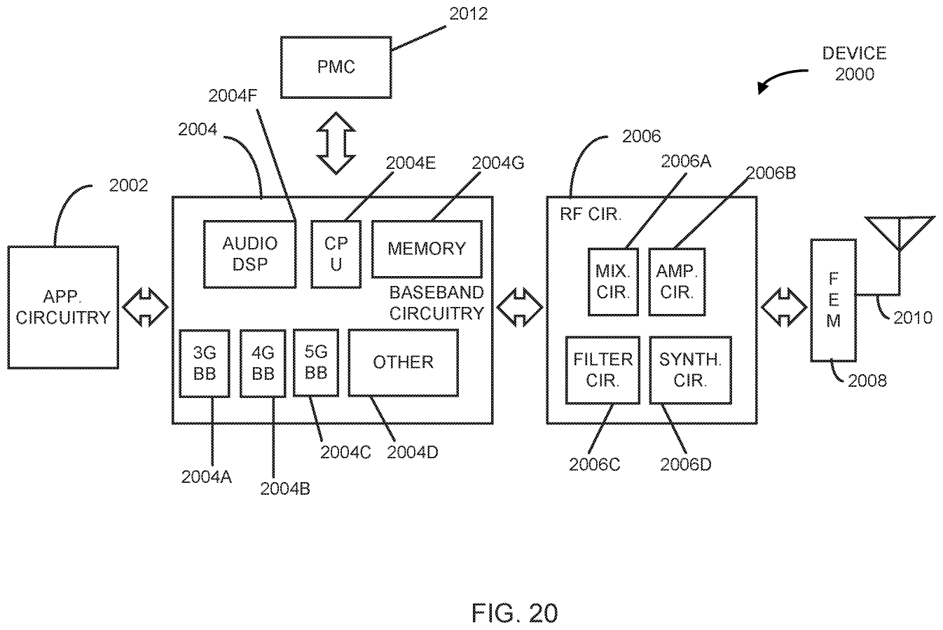

FIG. 20 illustrates example components of a device 2000 in accordance with some embodiments. In some embodiments, the device 2000 may include application circuitry 2002, baseband circuitry 2004, Radio Frequency (RF) circuitry 2006, front-end module (FEM) circuitry 2008, one or more antennas 2010, and power management circuitry (PMC) 2012 coupled together at least as shown. The components of the illustrated device 2000 may be included in a UE or a RAN node. In some embodiments, the device 2000 may include less elements (e.g., a RAN node may not utilize application circuitry 2002, and instead include a processor/controller to process IP data received from an EPC). In some embodiments, the device 2000 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 2002 may include one or more application processors. For example, the application circuitry 2002 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 2000. In some embodiments, processors of application circuitry 2002 may process IP data packets received from an EPC.

The baseband circuitry 2004 may include circuitry such as, but not limited to, one or more single-core or multi-core processors. The baseband circuitry 2004 may include one or more baseband processors or control logic to process baseband signals received from a receive signal path of the RF circuitry 2006 and to generate baseband signals for a transmit signal path of the RF circuitry 2006. Baseband processing circuitry 2004 may interface with the application circuitry 2002 for generation and processing of the baseband signals and for controlling operations of the RF circuitry 2006. For example, in some embodiments, the baseband circuitry 2004 may include a third generation (3G) baseband processor 2004A, a fourth generation (4G) baseband processor 2004B, a fifth generation (5G) baseband processor 2004C, or other baseband processor(s) 2004D for other existing generations, generations in development or to be developed in the future (e.g., second generation (2G), sixth generation (6G), etc.). The baseband circuitry 2004 (e.g., one or more of baseband processors 2004A-D) may handle various radio control functions that enable communication with one or more radio networks via the RF circuitry 2006. In other embodiments, some or all of the functionality of baseband processors 2004A-D may be included in modules stored in the memory 2004G and executed via a Central Processing Unit (CPU) 2004E. The radio control functions may include, but are not limited to, signal modulation/demodulation, encoding/decoding, radio frequency shifting, etc. In some embodiments, modulation/demodulation circuitry of the baseband circuitry 2004 may include Fast-Fourier Transform (FFT), precoding, or constellation mapping/demapping functionality. In some embodiments, encoding/decoding circuitry of the baseband circuitry 2004 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 2004 may include one or more audio digital signal processor(s) (DSP) 2004F. The audio DSP(s) 2004F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 2004 and the application circuitry 2002 may be implemented together such as, for example, on a system on a chip (SOC).

In some embodiments, the baseband circuitry 2004 may provide for communication compatible with one or more radio technologies. For example, in some embodiments, the baseband circuitry 2004 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 2004 is configured to support radio communications of more than one wireless protocol may be referred to as multi-mode baseband circuitry.

RF circuitry 2006 may enable communication with wireless networks using modulated electromagnetic radiation through a non-solid medium. In various embodiments, the RF circuitry 2006 may include switches, filters, amplifiers, etc. to facilitate the communication with the wireless network. RF circuitry 2006 may include a receive signal path which may include circuitry to down-convert RF signals received from the FEM circuitry 2008 and provide baseband signals to the baseband circuitry 2004. RF circuitry 2006 may also include a transmit signal path which may include circuitry to up-convert baseband signals provided by the baseband circuitry 2004 and provide RF output signals to the FEM circuitry 2008 for transmission.

In some embodiments, the receive signal path of the RF circuitry 2006 may include mixer circuitry 2006a, amplifier circuitry 2006b and filter circuitry 2006c. In some embodiments, the transmit signal path of the RF circuitry 2006 may include filter circuitry 2006c and mixer circuitry 2006a. RF circuitry 2006 may also include synthesizer circuitry 2006d for synthesizing a frequency for use by the mixer circuitry 2006a of the receive signal path and the transmit signal path. In some embodiments, the mixer circuitry 2006a of the receive signal path may be configured to down-convert RF signals received from the FEM circuitry 2008 based on the synthesized frequency provided by synthesizer circuitry 2006d. The amplifier circuitry 2006b may be configured to amplify the down-converted signals and the filter circuitry 2006c may be a low-pass filter (LPF) or band-pass filter (BPF) configured to remove unwanted signals from the down-converted signals to generate output baseband signals. Output baseband signals may be provided to the baseband circuitry 2004 for further processing. In some embodiments, the output baseband signals may be zero-frequency baseband signals, although this is not a necessity. In some embodiments, mixer circuitry 2006a of the receive signal path may comprise passive mixers, although the scope of the embodiments is not limited in this respect.

In some embodiments, the mixer circuitry 2006a of the transmit signal path may be configured to up-convert input baseband signals based on the synthesized frequency provided by the synthesizer circuitry 2006d to generate RF output signals for the FEM circuitry 2008. The baseband signals may be provided by the baseband circuitry 2004 and may be filtered by filter circuitry 2006c.

In some embodiments, the mixer circuitry 2006a of the receive signal path and the mixer circuitry 2006a of the transmit signal path may include two or more mixers and may be arranged for quadrature downconversion and upconversion, respectively. In some embodiments, the mixer circuitry 2006a of the receive signal path and the mixer circuitry 2006a of the transmit signal path may include two or more mixers and may be arranged for image rejection (e.g., Hartley image rejection). In some embodiments, the mixer circuitry 2006a of the receive signal path and the mixer circuitry 2006a may be arranged for direct downconversion and direct upconversion, respectively. In some embodiments, the mixer circuitry 2006a of the receive signal path and the mixer circuitry 2006a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 2006 may include analog-to-digital converter (ADC) and digital-to-analog converter (DAC) circuitry and the baseband circuitry 2004 may include a digital baseband interface to communicate with the RF circuitry 2006.

In some dual-mode embodiments, a separate radio IC circuitry may be provided for processing signals for each spectrum, although the scope of the embodiments is not limited in this respect.

In some embodiments, the synthesizer circuitry 2006d may be a fractional-N synthesizer or a fractional N/N+1 synthesizer, although the scope of the embodiments is not limited in this respect as other types of frequency synthesizers may be suitable. For example, synthesizer circuitry 2006d may be a delta-sigma synthesizer, a frequency multiplier, or a synthesizer comprising a phase-locked loop with a frequency divider.

The synthesizer circuitry 2006d may be configured to synthesize an output frequency for use by the mixer circuitry 2006a of the RF circuitry 2006 based on a frequency input and a divider control input. In some embodiments, the synthesizer circuitry 2006d may be a fractional N/N+1 synthesizer.

In some embodiments, frequency input may be provided by a voltage controlled oscillator (VCO), although that is not a necessity. Divider control input may be provided by either the baseband circuitry 2004 or the applications processor 2002 depending on the desired output frequency. In some embodiments, a divider control input (e.g., N) may be determined from a look-up table based on a channel indicated by the applications processor 2002.

Synthesizer circuitry 2006d of the RF circuitry 2006 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 2006d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 2006 may include an IQ/polar converter.

FEM circuitry 2008 may include a receive signal path which may include circuitry configured to operate on RF signals received from one or more antennas 2010, amplify the received signals and provide the amplified versions of the received signals to the RF circuitry 2006 for further processing. FEM circuitry 2008 may also include a transmit signal path which may include circuitry configured to amplify signals for transmission provided by the RF circuitry 2006 for transmission by one or more of the one or more antennas 2010. In various embodiments, the amplification through the transmit or receive signal paths may be done solely in the RF circuitry 2006, solely in the FEM 2008, or in both the RF circuitry 2006 and the FEM 2008.

In some embodiments, the FEM circuitry 2008 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 2006). The transmit signal path of the FEM circuitry 2008 may include a power amplifier (PA) to amplify input RF signals (e.g., provided by RF circuitry 2006), and one or more filters to generate RF signals for subsequent transmission (e.g., by one or more of the one or more antennas 2010).

In some embodiments, the PMC 2012 may manage power provided to the baseband circuitry 2004. In particular, the PMC 2012 may control power-source selection, voltage scaling, battery charging, or DC-to-DC conversion. The PMC 2012 may often be included when the device 2000 is capable of being powered by a battery, for example, when the device is included in a UE. The PMC 2012 may increase the power conversion efficiency while providing desirable implementation size and heat dissipation characteristics.

While FIG. 20 shows the PMC 2012 coupled only with the baseband circuitry 2004. However, in other embodiments, the PMC 2012 may be additionally or alternatively coupled with, and perform similar power management operations for, other components such as, but not limited to, application circuitry 1602, RF circuitry 2006, or FEM 2008.

In some embodiments, the PMC 2012 may control, or otherwise be part of, various power saving mechanisms of the device 2000. For example, if the device 2000 is in an RRC_Connected state, where it is still connected to the RAN node as it expects to receive traffic shortly, then it may enter a state known as Discontinuous Reception Mode (DRX) after a period of inactivity. During this state, the device 2000 may power down for brief intervals of time and thus save power.

If there is no data traffic activity for an extended period of time, then the device 2000 may transition off to an RRC Idle state, where it disconnects from the network and does not perform operations such as channel quality feedback, handover, etc. The device 2000 goes into a very low power state and it performs paging where again it periodically wakes up to listen to the network and then powers down again. The device 2000 may not receive data in this state, in order to receive data, it can transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 2002 and processors of the baseband circuitry 2004 may be used to execute elements of one or more instances of a protocol stack. For example, processors of the baseband circuitry 2004, alone or in combination, may be used execute Layer 3, Layer 2, or Layer 1 functionality, while processors of the application circuitry 2004 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

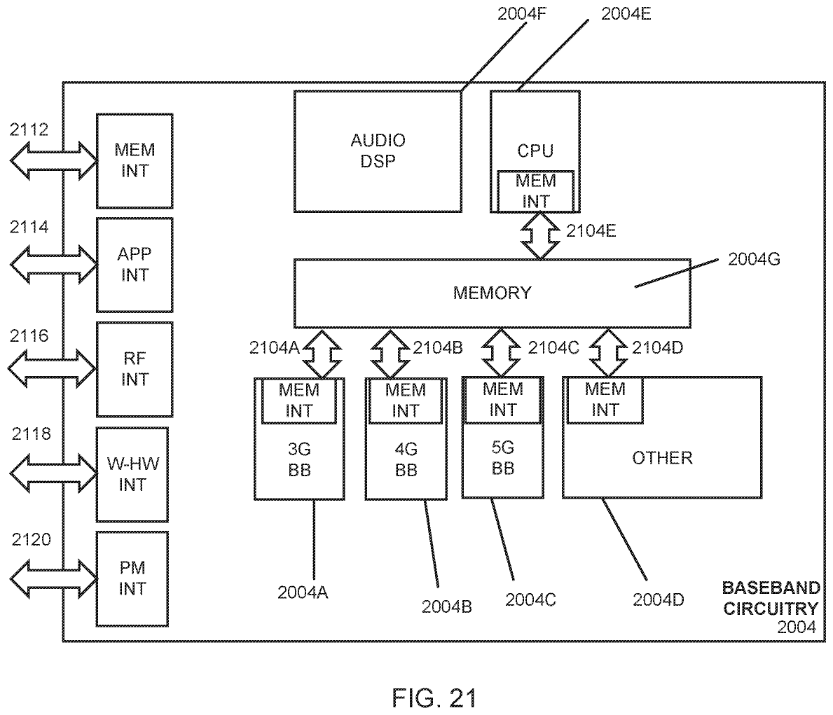

FIG. 21 illustrates example interfaces of baseband circuitry in accordance with some embodiments. As discussed above, the baseband circuitry 2004 of FIG. 20 may comprise processors 2004A-2004E and a memory 2004G utilized by said processors. Each of the processors 2004A-2004E may include a memory interface, 2104A-2104E, respectively, to send/receive data to/from the memory 2004G.

The baseband circuitry 2004 may further include one or more interfaces to communicatively couple to other circuitries/devices, such as a memory interface 2112 (e.g., an interface to send/receive data to/from memory external to the baseband circuitry 2004), an application circuitry interface 2114 (e.g., an interface to send/receive data to/from the application circuitry 2002 of FIG. 20), an RF circuitry interface 2116 (e.g., an interface to send/receive data to/from RF circuitry 2006 of FIG. 20), a wireless hardware connectivity interface 2118 (e.g., an interface to send/receive data to/from Near Field Communication (NFC) components, Bluetooth® components (e.g., Bluetooth® Low Energy), Wi-Fi® components, and other communication components), and a power management interface 2120 (e.g., an interface to send/receive power or control signals to/from the PMC 2012.

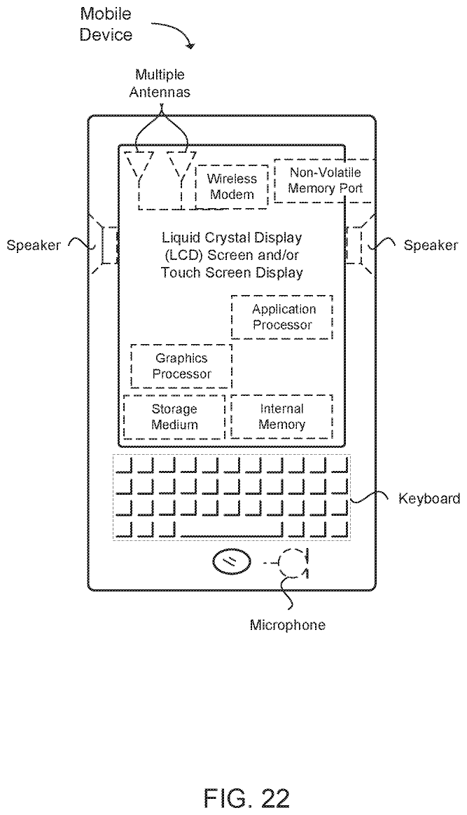

FIG. 22 provides an example illustration of the wireless device, such as a user equipment (UE), a mobile station (MS), a mobile wireless device, a mobile communication device, a tablet, a handset, or other type of wireless device. The wireless device can include one or more antennas configured to communicate with a node, macro node, low power node (LPN), or, transmission station, such as a base station (BS), an evolved Node B (eNB), a baseband processing unit (BBU), a remote radio head (RRH), a remote radio equipment (RRE), a relay station (RS), a radio equipment (RE), or other type of wireless wide area network (WWAN) access point. The wireless device can be configured to communicate using at least one wireless communication standard such as, but not limited to, 3GPP LTE, WiMAX, High Speed Packet Access (HSPA), Bluetooth, and WiFi. The wireless device can communicate using separate antennas for each wireless communication standard or shared antennas for multiple wireless communication standards. The wireless device can communicate in a wireless local area network (WLAN), a wireless personal area network (WPAN), and/or a WWAN. The wireless device can also comprise a wireless modem. The wireless modem can comprise, for example, a wireless radio transceiver and baseband circuitry (e.g., a baseband processor). The wireless modem can, in one example, modulate signals that the wireless device transmits via the one or more antennas and demodulate signals that the wireless device receives via the one or more antennas.

FIG. 22 also provides an illustration of a microphone and one or more speakers that can be used for audio input and output from the wireless device. The display screen can be a liquid crystal display (LCD) screen, or other type of display screen such as an organic light emitting diode (OLED) display. The display screen can be configured as a touch screen. The touch screen can use capacitive, resistive, or another type of touch screen technology. An application processor and a graphics processor can be coupled to internal memory to provide processing and display capabilities. A non-volatile memory port can also be used to provide data input/output options to a user. The non-volatile memory port can also be used to expand the memory capabilities of the wireless device. A keyboard can be integrated with the wireless device or wirelessly connected to the wireless device to provide additional user input. A virtual keyboard can also be provided using the touch screen.

### EXAMPLES

The following examples pertain to specific technology embodiments and point out specific features, elements, or actions that can be used or otherwise combined in achieving such embodiments.

Example 1 includes an apparatus of a next generation node B (gNB), operable for new radio (NR) unlicensed communication, the apparatus comprising: one or more processors configured to: encode a discovery reference signal (DRS) in a single subframe, the DRS comprising: a first synchronization signal (SS) block comprising a plurality of contiguous orthogonal frequency division multiplexed (OFDM) symbols in the single subframe; a second SS block comprising a plurality of contiguous OFDM symbols in the single subframe; and a plurality of additional OFDM symbols for an SS block in the single subframe; and send the DRS in the single subframe to a user equipment (UE); and a memory interface configured to send to a memory the DRS.

Example 2 includes the apparatus of the gNB of example 1, wherein the one or more processors are further configured to select a first two symbols in the single subframe to be reserved for a physical downlink control channel (PDCCH).

Example 3 includes the apparatus of the gNB of example 1, wherein the one or more processors are further configured to encode the first SS block in four contiguous symbols located after OFDM symbols in the single subframe that are reserved for physical downlink control channel (PDCCH) transmission.

Example 4 includes the apparatus of the gNB of example 1, wherein the one or more processors are further configured to encode the second SS block in four contiguous symbols located adjacent to the first SS block.

Example 5 includes the apparatus of the gNB of example 1 to 4, wherein the one or more processors are further configured to encode the plurality of additional OFDM symbols in four adjacent symbols located adjacent to the second SS block.

Example 6 includes the apparatus of the gNB of example 1 and 3, wherein the one or more processors are further configured to encode the second SS block with in four adjacent symbols that are located after the first SS block, wherein the additional ODFM symbols are located prior to and after the second SS block in the single subframe.

Example 7 includes the apparatus of the gNB of example 1, wherein the one or more processors are further configured to: encode an extended SS block in five or six contiguous symbols located after OFDM symbols in the single subframe that are reserved for physical downlink control channel (PDCCH) transmission; and encode the second SS block in five or six contiguous symbols located adjacent to the first SS block.

Example 8 includes the apparatus of the gNB of example 7, wherein the one or more processors are further configured to encode a primary synchronization signal (PSS), a secondary synchronization signal (SSS), or a physical broadcast channel (PBCH) in the extended SS block.

Example 9 includes the apparatus of the gNB of example 7, wherein the one or more processors are further configured to select one or more of the additional OFDM symbols for transmission of a physical broadcast channel (PBCH), wherein each of the additional OFDM symbols are rate matched to three OFDM symbols or repeated in a second transmission.

Example 10 includes the apparatus of the gNB of example 1, wherein the one or more processors are further configured to: select one or more of the additional OFDM symbols for broadcasting a system information block (SIB) or a page in a physical downlink shared channel (PDSCH) transmission; or

select the one or more additional OFDM symbols for unicast broadcasting in the PDSCH transmission.

Example 11 includes the apparatus of the gNB of example 1, wherein the one or more processors are further configured to encode multiple DRS within the single subframe using resource blocks (RBs) in the frequency domain.

Example 12 includes an apparatus of a user equipment (UE), configured for floating physical uplink shared channel (PUSCH) transmission, the apparatus comprising: one or more processors configured to: decode downlink control information (DCI) in a physical downlink control channel (PDCCH); identify a starting orthogonal frequency division multiplexed (OFDM) symbol and a number of OFDM symbols for a physical uplink shared channel (PUSCH) transmission; perform a listen-before-talk (LBT) at the starting OFDM symbol of the PUSCH transmission; perform a LBT at a next OFDM symbol in the PUSCH transmission when a channel is not acquired in the starting OFDM symbol; and encode data in the number of OFDM symbols, for transmission to a UE, after a successful LBT instance; and a memory interface configured to send to a memory the data.

Example 13 includes the apparatus of the UE of example 12, wherein the one or more processors are further configured to: encode the data for transmission in the number of OFDM symbols after the LBT succeeds; delay the encoded data based on a number of OFDM symbols used for the LBT; puncture tail OFDM symbols of the delayed encoded data based on the number of OFDM symbols used for the LBT; and scramble the delayed encoded data in the number of OFDM symbols using a scrambling sequence that is generated based on time information of a first configured OFDM symbol index of the starting OFDM symbol.

Example 14 includes the apparatus of the UE of example 12, wherein the one or more processors are further configured to: encode the data for transmission in the number of OFDM symbols after the LBT succeeds; delay the encoded data based on a number of OFDM symbols used for the LBT; puncture starting OFDM symbols of the delayed encoded data that have a starting time that is earlier in time than a completion of the successful LBT instance; and send a remaining OFDM symbols of the number of OFDM symbols to the UE.

Example 15 includes the apparatus of the UE of example 14, wherein the one or more processors are further configured to: encode the data for transmission in the remaining OFDM symbols, where the data is encoded with sufficient density to enable a next generation node B to perform blind detection on each of the remaining OFDM symbols.

Example 16 includes the apparatus of the UE of example 14, wherein the one or more processors are further configured to: encode a first symbol of the remaining OFDM symbols with sufficient demodulation reference signal (DMRS) density, to enable a next generation Node B gNB to blindly detect a starting of the PUSCH transmission.

Example 17 includes the apparatus of the UE of example 16, wherein the one or more processors are further configured to: encode the first symbol of the remaining OFDM symbols with a full DMRS symbol having a scrambling sequence that is generated based on time information of a first configured OFDM symbol index of the starting OFDM symbol; or encode the first symbol of the remaining OFDM symbols with a higher DMRS density than a DMRS density of following symbols.

Example 18 includes the apparatus of the UE of example 12, wherein the one or more processors are further configured to: map the data in the number of OFDM symbols, wherein the mapping comprises frequency mapping first, and then time mapping.

Example 19 includes the apparatus of the UE of example 12, wherein the one or more processors are further configured to: encode one or more OFDM symbols in the number of OFDM symbols for transmission in a separate PUSCH transmission to reduce a loss of data due to puncturing.

Example 20 includes the apparatus of the UE of example 12, wherein the one or more processors are further configured to: decode a starting OFDM symbol for a PUSCH transmission, received from a next generation Node B (gNB) in downlink control information or radio resource control (RRC) signaling.

Example 21 includes the apparatus of the UE of example 12, wherein the one or more processors are further configured to: decode one or more LBTs received from a next generation node B.

Example 22 includes an apparatus of a user equipment (UE) configured to send uplink control information (UCI) in a new radio (NR) unlicensed physical uplink control channel (PUCCH), the apparatus comprising: one or more processors configured to: encode UCI in a short PUCCH having an interlaced structure based on Block-Interleaved Frequency Division Multiple Access (B-IFDMA) for transmission to a next generation node B (gNB) for a low UCI capacity; or encode UCI in a long PUCCH having an interlaced structure based on Block-Interleaved Frequency Division Multiple Access (B-IFDMA) for transmission to a next generation node B (gNB) to support a larger UCI capacity than the short PUCCH; and decode a downlink control information (DCI) sent in a physical downlink control channel (PDCCH) to determine a listen before talk (LBT) type prior to transmission of the short PUCCH or the long PUCCH; and a memory interface configured to send to a memory the UCI.

Example 23 includes the apparatus of the UE of example 22, wherein the one or more processors are further configured to: decode the DCI sent in the PDCCH; and identify the LBT type, in a one-bit indicator in the DCI.

Example 24 includes the apparatus of the UE of example 23, wherein the one or more processors are further configured to: determine the LBT type from the one-bit indicator wherein a first bit type indicates no LBT and a second bit type indicates a one shot LBT.

Example 25 includes the apparatus of the UE of example 22, wherein the one or more processors are further configured to: decode the DCI sent in the PDCCH; and identify the LBT type, in a two-bit indicator in the DCI.

Example 26 includes the apparatus of the UE of example 25, wherein the one or more processors are further configured to: determine the LBT type from the two-bit indicator wherein: a first bit type indicates no LBT; a second bit type indicates a one shot LBT; and a third bit type indicates a category 4 (Cat. 4) LBT.

Example 27 includes the apparatus of the UE of example 26, wherein the one or more processors are further configured to: decode a priority class of the Cat. 4 LBT, wherein the priority class is received in a radio resource control (RRC) message from the gNB.

Various techniques, or certain aspects or portions thereof, may take the form of program code (i.e., instructions) embodied in tangible media, such as floppy diskettes, compact disc-read-only memory (CD-ROMs), hard drives, non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a random-access memory (RAM), erasable programmable read only memory (EPROM), flash drive, optical drive, magnetic hard drive, solid state drive, or other medium for storing electronic data. The node and wireless device may also include a transceiver module (i.e., transceiver), a counter module (i.e., counter), a processing module (i.e., processor), and/or a clock module (i.e., clock) or timer module (i.e., timer). In one example, selected components of the transceiver module can be located in a cloud radio access network (C-RAN). One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

It should be understood that many of the functional units described in this specification have been labeled as modules, in order to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module may not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Reference throughout this specification to “an example” or “exemplary” means that a particular feature, structure, or characteristic described in connection with the example is included in at least one embodiment of the present technology. Thus, appearances of the phrases “in an example” or the word “exemplary” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present technology may be referred to herein along with alternatives for the various components thereof. It is understood that such embodiments, examples, and alternatives are not to be construed as defacto equivalents of one another, but are to be considered as separate and autonomous representations of the present technology.

Furthermore, the described features, structures, or characteristics may be combined in any suitable manner in one or more embodiments. In the following description, numerous specific details are provided, such as examples of layouts, distances, network examples, etc., to provide a thorough understanding of embodiments of the technology. One skilled in the relevant art will recognize, however, that the technology can be practiced without one or more of the specific details, or with other methods, components, layouts, etc. In other instances, well-known structures, materials, or operations are not shown or described in detail to avoid obscuring aspects of the technology.

While the forgoing examples are illustrative of the principles of the present technology in one or more particular applications, it will be apparent to those of ordinary skill in the art that numerous modifications in form, usage and details of implementation can be made without the exercise of inventive faculty, and without departing from the principles and concepts of the technology. Accordingly, it is not intended that the technology be limited, except as by the claims set forth below.

What is claimed is:

1. An apparatus of a next generation node B (gNB), operable for new radio (NR) unlicensed communication, the apparatus comprising:
one or more processors configured to:
encode a discovery reference signal (DRS) in a single subframe, the DRS comprising:
a first synchronization signal (SS) block comprising a plurality of contiguous orthogonal frequency division multiplexed (OFDM) symbols in the single subframe;
a second SS block comprising a plurality of contiguous OFDM symbols in the single subframe; and
a plurality of additional OFDM symbols for an SS block in the single subframe; and
send the DRS in the single subframe to a user equipment (UE); and
a memory interface configured to send to a memory the DRS.

2. The apparatus of the gNB of claim 1, wherein the one or more processors are further configured to select a first two symbols in the single subframe to be reserved for a physical downlink control channel (PDCCH).

3. The apparatus of the gNB of claim 1, wherein the one or more processors are further configured to encode the first SS block in four contiguous symbols located after OFDM symbols in the single subframe that are reserved for physical downlink control channel (PDCCH) transmission.

4. The apparatus of the gNB of claim 1, wherein the one or more processors are further configured to encode the second SS block in four contiguous symbols located adjacent to the first SS block.

5. The apparatus of the gNB of claims 1 to 4, wherein the one or more processors are further configured to encode the plurality of additional OFDM symbols in four adjacent symbols located adjacent to the second SS block.

6. The apparatus of the gNB of claims 1 and 3, wherein the one or more processors are further configured to encode the second SS block with in four adjacent symbols that are located after the first SS block, wherein the additional ODFM symbols are located prior to and after the second SS block in the single subframe.

7. The apparatus of the gNB of claim 1, wherein the one or more processors are further configured to:
encode an extended SS block in five or six contiguous symbols located after OFDM symbols in the single subframe that are reserved for physical downlink control channel (PDCCH) transmission; and
encode the second SS block in five or six contiguous symbols located adjacent to the first SS block.

8. The apparatus of the gNB of claim 7, wherein the one or more processors are further configured to encode a primary synchronization signal (PSS), a secondary synchronization signal (SSS), or a physical broadcast channel (PBCH) in the extended SS block.

9. The apparatus of the gNB of claim 7, wherein the one or more processors are further configured to select one or more of the additional OFDM symbols for transmission of a physical broadcast channel (PBCH), wherein each of the additional OFDM symbols are rate matched to three OFDM symbols or repeated in a second transmission.

10. The apparatus of the gNB of claim 1, wherein the one or more processors are further configured to:
select one or more of the additional OFDM symbols for broadcasting a system information block (SIB) or a page in a physical downlink shared channel (PDSCH) transmission; or
select the one or more additional OFDM symbols for unicast broadcasting in the PDSCH transmission.

11. The apparatus of the gNB of claim 1, wherein the one or more processors are further configured to encode multiple DRS within the single subframe using resource blocks (RBs) in the frequency domain.

12. The apparatus of a user equipment (UE), configured for floating physical uplink shared channel (PUSCH) transmission, the apparatus comprising:
one or more processors configured to:
decode downlink control information (DCI) in a physical downlink control channel (PDCCH);
identify a starting orthogonal frequency division multiplexed (OFDM) symbol and a number of OFDM symbols for a physical uplink shared channel (PUSCH) transmission;
perform a listen-before-talk (LBT) at the starting OFDM symbol of the PUSCH transmission;
perform a LBT at a next OFDM symbol in the PUSCH transmission when a channel is not acquired in the starting OFDM symbol; and
encode data in the number of OFDM symbols, for transmission to a UE, after a successful LBT instance; and
a memory interface configured to send to a memory the data.

13. The apparatus of the UE of claim 12, wherein the one or more processors are further configured to:
encode the data for transmission in the number of OFDM symbols after the LBT succeeds;
delay the encoded data based on a number of OFDM symbols used for the LBT;
puncture tail OFDM symbols of the delayed encoded data based on the number of OFDM symbols used for the LBT; and
scramble the delayed encoded data in the number of OFDM symbols using a scrambling sequence that is generated based on time information of a first configured OFDM symbol index of the starting OFDM symbol.

14. The apparatus of the UE of claim 12, wherein the one or more processors are further configured to:
encode the data for transmission in the number of OFDM symbols after the LBT succeeds;
delay the encoded data based on a number of OFDM symbols used for the LBT;
puncture starting OFDM symbols of the delayed encoded data that have a starting time that is earlier in time than a completion of the successful LBT instance; and
send a remaining OFDM symbols of the number of OFDM symbols to the UE.

15. The apparatus of the UE of claim 14, wherein the one or more processors are further configured to:
encode the data for transmission in the remaining OFDM symbols, where the data is encoded with sufficient density to enable a next generation node B to perform blind detection on each of the remaining OFDM symbols.

16. The apparatus of the UE of claim 14, wherein the one or more processors are further configured to:
encode a first symbol of the remaining OFDM symbols with sufficient demodulation reference signal (DMRS) density, to enable a next generation Node B gNB to blindly detect a starting of the PUSCH transmission.

17. The apparatus of the UE of claim 16, wherein the one or more processors are further configured to:
encode the first symbol of the remaining OFDM symbols with a full DMRS symbol having a scrambling sequence that is generated based on time information of a first configured OFDM symbol index of the starting OFDM symbol; or
encode the first symbol of the remaining OFDM symbols with a higher DMRS density than a DMRS density of following symbols.

18. The apparatus of the UE of claim 12, wherein the one or more processors are further configured to:
map the data in the number of OFDM symbols, wherein the mapping comprises frequency mapping first, and then time mapping.

19. The apparatus of the UE of claim 12, wherein the one or more processors are further configured to:
encode one or more OFDM symbols in the number of OFDM symbols for transmission in a separate PUSCH transmission to reduce a loss of data due to puncturing.

20. The apparatus of the UE of claim 12, wherein the one or more processors are further configured to:
decode a starting OFDM symbol for a PUSCH transmission, received from a next generation Node B (gNB) in downlink control information or radio resource control (RRC) signaling.

21. The apparatus of the UE of claim 12, wherein the one or more processors are further configured to:
decode one or more LBTs received from a next generation node B.

22. The apparatus of a user equipment (UE) configured to send uplink control information (UCI) in a new radio (NR) unlicensed physical uplink control channel (PUCCH), the apparatus comprising:
one or more processors configured to:
encode UCI in a short PUCCH having an interlaced structure based on Block-Interleaved Frequency Division Multiple Access (B-IFDMA) for transmission to a next generation node B (gNB) for a low UCI capacity; or
encode UCI in a long PUCCH having an interlaced structure based on Block-Interleaved Frequency Division Multiple Access (B-IFDMA) for transmission to a next generation node B (gNB) to support a larger UCI capacity than the short PUCCH; and
decode a downlink control information (DCI) sent in a physical downlink control channel (PDCCH) to determine a listen before talk (LBT) type prior to transmission of the short PUCCH or the long PUCCH; and
a memory interface configured to send to a memory the UCI.

23. The apparatus of the UE of claim 22, wherein the one or more processors are further configured to:
decode the DCI sent in the PDCCH; and
identify the LBT type, in a one-bit indicator in the DCI.

24. The apparatus of the UE of claim 23, wherein the one or more processors are further configured to:
determine the LBT type from the one-bit indicator wherein a first bit type indicates no LBT and a second bit type indicates a one shot LBT.

25. The apparatus of the UE of claim 22, wherein the one or more processors are further configured to:
decode the DCI sent in the PDCCH; and
identify the LBT type, in a two-bit indicator in the DCI.

26. The apparatus of the UE of claim 25, wherein the one or more processors are further configured to:
determine the LBT type from the two-bit indicator wherein:
a first bit type indicates no LBT;
a second bit type indicates a one shot LBT; and
a third bit type indicates a category 4 (Cat. 4) LBT.

27. The apparatus of the UE of claim 26, wherein the one or more processors are further configured to:
decode a priority class of the Cat. 4 LBT, wherein the priority class is received in a radio resource control (RRC) message from the gNB.
